(19) United States
(12) Patent Application Publication
(10) Pub. No.: US 2016/0076480 A1
(43) Pub. Date: Mar. 17, 2016

(54) VALVE SEATS FOR CYLINDER HEADS IN AIRCRAFT ENGINES

(71) Applicant: David ENDRIGO, KEYPORT, WA (US)

(72) Inventor: David ENDRIGO, KEYPORT, WA (US)

(21) Appl. No.: 14/802,986

(22) Filed: Jul. 17, 2015

Related U.S. Application Data
(63) Continuation-in-part of application No. 13/955,365, filed on Jul. 31, 2013, now abandoned.
Application No. 13/955,365 is a continuation-in-part of application No. 13/756,891, filed on Feb. 1, 2013, now abandoned.
(60) Provisional application No. 61/595,049, filed on Feb. 4, 2012.

(51) Int. Cl. F02F 1/42

(52) U.S. Cl. CPC F02F 1/42

(57) ABSTRACT

Intake and exhaust valve seat inserts for aircraft cylinder heads. The inserts are configured for low pressure loss as inlet air and hot exhaust gas passes through the respective valve seat inserts. In an embodiment, the intake and exhaust valve seat inserts may have a plurality of faces or facets, at prescribed angles, in order to minimize pressure loss of gases passing therethrough. In an embodiment, rather than a plurality of faces or facets, the intake valve seat sidewall, and/or the exhaust valve seat sidewall may be provided in the configuration of a smooth curve approximating a set of selected angles, as if the component were made with a plurality of facets.

### RELATED PATENT APPLICATIONS

This application is a Continuation-In-Part of U.S. patent application Ser. No. 13/955,365, filed on Jul. 31, 2013, which application is a Continuation-In-Part of U.S. patent application Ser. No. 13/756,891, filed on Feb. 1, 2013, which application claimed priority from prior U.S. Provisional Patent Application Ser. No. 61/595,049, filed Feb. 4, 2012, entitled CYLINDER HEADS FOR AIRCRAFT ENGINES, the disclosures of each are incorporated herein in their entirety, including their specification, drawing, and claims, by this reference.

### COPYRIGHT NOTICE

A portion of the disclosure of this patent document contains drawing materials that are subject to copyright protection. The owner has no objection to the facsimile reproduction by anyone of the patent document or patent disclosure, as it appears in the U.S. Patent and Trademark Office patent file or records, but otherwise reserves all copyright rights whatsoever.

### TECHNICAL FIELD

The present disclosure relates to aircraft engines, and more specifically, to improved designs for valve seats in cylinder heads in aircraft engines.

### BACKGROUND

Aircraft engines commonly in use in general aviation aircraft are primarily provided in an internal combustion, multi-cylinder, spark ignition configuration which is set up for the combustion of high octane aviation gasoline. Such engines are generally air cooled, with individually mounted cylinders, which in the trade are often called cylinder “jugs”. Cylinder jugs typically include a head portion and a cylinder portion. Each of such portions usually includes a plurality of cooling flanges to exchange heat with air passing the cylinder. Each engine is configured to route incoming combustion air through the head portion to the cylinder, and to route the hot exhaust gases out of the cylinder through the head portion to an exhaust header or manifold. Control of relatively cool combustion air entering the cylinder, and of hot exhaust gases leaving the cylinder, is accomplished by intake and exhaust valves operating in conventional fashion.

Cylinder heads in current general aviation aircraft engine designs include inlet passageways for incoming air flow, and outlet passageways for the outgoing exhaust gases, each of which passageways were in most cases designed decades ago. Little attention seems to have been given to optimizing the engine power output by optimization of the flow path for the incoming air, or of the flow path for the outgoing hot exhaust gases, or to the various portions of the intake valve seat, or to the various portions of the exhaust valve seat.

In various non-aviation engines, some attempts have been made, with varying degrees of success, to provide an upgrade to the inlet passageways or inlet valve seats, or to the exhaust valve seats or exhaust outlet passageways, to at least in part compensate for poor original designs of cylinder head components. With regard to inlet air passageways, an attempt at obtaining improved performance is described in U.S. Pat. No. 4,159,011, issued Jun. 26, 1979, for an Engine Cylinder Inlet Port, and which was assigned to General Motors Corporation, of Detroit, Mich. In the described apparatus, a shaped flow deflector provided some improvement with respect to inlet air flow; however, that design leaves considerable room for improvement. With regard to exhaust gas outlet passageways, an attempt to obtain improved performance is described in U.S. Pat. No. 4,537,028, issued Aug. 27, 1985, for an Exhaust Port, and which is assigned to Deere & Company, of Moline, Ill. In that design, flow dividers were provided around a valve stem, which reduced flow separation and loses. However, the configurations of such cylinder heads allow somewhat more latitude in what may be adjusted than the typical aircraft engine cylinder, and the aircraft cylinder heads and passageways therein.

Thus, in spite of prior art for attempts at improving air flow in other types of internal combustion, multi-cylinder spark ignition engines, there still remains an as yet unmet need for an improved cylinder head, including the intake valve seats and the exhaust valve sates in aircraft engines which can simply and effectively improve total engine power output. It would be advantageous to provide such a design by unique modifications to the current designs used for intake and exhaust valve seats in aircraft cylinder heads, so that adjacent (or other) engine components could be used with little or no modification (except as may be advantageous or necessary to accommodate the air flow volume and power output improvements as taught herein). Importantly, the use of such an improved intake valve seats and exhaust valve seats in an improved cylinder head design would provide increased horsepower output from existing aircraft engines. Such improvement would be particularly helpful when maximum engine performance is required, such as for short field takeoffs, and/or in high density altitude conditions. Alternatively, and just as important, an improved engine, using improved cylinder head designs as described herein, may be utilized in a method of operation to reduce fuel consumption at a given horsepower output, as compared to fuel consumption rates in engines that use existing cylinder head designs and components. Thus, fuel consumption for a given trip distance would decrease, as compared to a prior art engine design; such improved performance would also extend the range of an aircraft employing such improved cylinder head designs.

Objects, Advantages, and Novel Features

Novel cylinder heads for aircraft engines as disclosed herein include an inlet passageway that is optimized to allow maximum airflow, by minimizing pressure drop (friction and flow turbulence losses) of air traversing through the inlet air passageway. Further, the inlet valve seat is optimized in shape to minimize pressure drop at inlet air flow rates. Likewise, the outlet valve seat is optimized in shape to minimize pressure drop as hot exhaust gases pass outward therethrough. And finally, the hot exhaust passageway is optimized to allow maximum exhaust flow, by minimizing the pressure drop (including friction and flow turbulence losses) experienced by exhaust gases, by minimizing obstructions to the outbound passage of high velocity hot exhaust gases.

The novel cylinder heads described herein are particularly advantageous in that they are configured to allow installation by an engine manufacturer on a new engine otherwise using existing design configurations, and thus allowing an increase in the horsepower output without the necessity to modify various other existing components. And, such novel cylinder heads (including novel intake and exhaust valve seats) could be substituted in the field, for example, during a “top overhaul” of an aircraft engine, to likewise improve horsepower output of a selected engine, and/or to reduce fuel consumption at a selected power output, as compared to the stock cylinders and heads. Such novel cylinder heads may be provided for overhauls as the key component of factory provided new cylinder kits for use in overhauls of existing engines.

Further, in an embodiment, it is an advantage that improved intake valves and intake valve seat configurations, and/or improved exhaust valves and exhaust valve seat configurations, may be used to provide yet further increases in power output, and in fuel economy, as compared to cylinder designs that only include new, improved inlet passageway and/or exhaust passageway designs described herein.

It is an advantage that improved cylinder heads provided by the designs disclosed herein may be manufactured using aluminum alloy castings, as presently used in many existing aircraft cylinder head designs.

These and other objects, advantages, and novel features of the cylinder head designs for aircraft engines as described herein will become apparent to the reader from the foregoing and from the appended claims, and the ensuing detailed description, as the discussion below proceeds in connection with examination of the accompanying figures of the drawing.

### SUMMARY

I have now developed improved intake valve seats and exhaust valve seats designed for aircraft engines. Such components may be easily and quickly installed in existing cylinder heads, or new engines that are otherwise of existing design, or may be easily and quickly installed on used engines, such as during an overhaul, when it may be useful to install new cylinders and related components, such as valves and/or cylinder heads.

The novel aircraft intake valve seat and exhaust valve seat designs disclosed herein may be scaled up or down as appropriate for the inlet airflow volume and exhaust gas flow volume resulting from the displacement provided by a particular cylinder. As an example, Lycoming Engines (a division of AVCO Corp., a Textron subsidiary), of Williamsport, Pa., produces a line of horizontally opposed, air cooled aircraft engines, with four, six, and eight cylinders, which in various configurations have from about 58 cubic inches displacement per cylinder to about 90 cubic inches displacement per cylinder. While the cylinder bore and head component dimensions for the various displacement sized cylinders are adjusted accordingly, the general principles described and claimed herein may be applied, and size variances easily accommodated.

The foregoing briefly describes certain aspects and elements of exemplary intake valve seats and exhaust valve seats for use in cylinder heads for aircraft engines, and various components thereof. The various objectives, features and advantages of the invention(s) will be more readily understood upon consideration of the detailed description, taken in conjunction with careful examination of the accompanying figures of the drawing.

### BRIEF DESCRIPTION OF DRAWINGS

In order to enable the reader to attain a more complete appreciation of the invention, and of the novel features and advantages thereof, attention is directed to the following detailed description when considered in connection with the accompanying figures of the drawing, wherein:

FIG. 1 is a partial cross-section view through an embodiment of an aircraft cylinder head, showing the upper reaches of an air cooled cylinder, and showing the cylinder head including a portion of a combustion air inlet passageway in which gas flow has been enhanced by shaping the passageway, an intake valve and associated intake valve guide, the intake valve seat, the upper reaches of the combustion chamber within the cylinder jug, the exhaust valve seat, the exhaust valve with associated exhaust valve guide, and showing a portion of the hot exhaust exit outlet passageway in which gas flow has been enhanced by shaped passageways.

FIG. 2 provides a side perspective view of an embodiment of an aircraft cylinder head of the type just set forth in FIG. 1 above, now showing the intake flange and the exhaust flange, and indicating the reduced flow cross-sectional area (at the intake flange) of the combustion air inlet passageway, and of the exhaust gas outlet passageway (at the exhaust flange), as compared to the respective prior art passageway shapes as set forth in broken lines.

FIG. 3 provides perspective view of a prior art intake valve design for use in an aircraft engine cylinder head.

FIG. 4 provides a side elevation view of an intake valve design for use in an aircraft engine cylinder head, showing improved intake valve design which enhances flow through the combustion air inlet passageway adjacent the intake valve.

FIG. 4A provides a partial side elevation view of a portion of an intake valve design for use in an aircraft engine cylinder head, showing details for an improved intake valve design which enhances flow through the combustion air inlet passageway, as adjacent the intake valve.

FIG. 5 provides perspective view of a prior art exhaust valve design for use in an aircraft engine cylinder head.

FIG. 6 provides a side elevation view of an exhaust valve design for use in an aircraft engine cylinder head, showing improved exhaust valve design which enhances flow through the hot exhaust gas outlet passageway, as adjacent the exhaust valve.

FIG. 6A provides a partial side elevation view of a portion of an exhaust valve design for use in an aircraft engine cylinder head, showing details for an improved exhaust valve design which enhances flow through the hot exhaust gas outlet passageway, as adjacent the exhaust valve.

FIG. 7 shows a partial cross-sectional view of an aircraft engine cylinder jug, taken transversely through the head portion such as through line 7-7 of FIG. 2, showing a portion of the cylinder and cylinder head, and the combustion air inlet passageway, with various cross-sections noted, as depicted in FIG. 8, FIG. 9, FIG. 10, FIG. 11, and the location of an upward view of the intake valve seat area and upstream combustion air inlet passageway as shown in FIG. 12.

FIG. 8 shows a cross-sectional view taken at line 8-8 of FIG. 7, indicating the cross-sectional shape at the noted location of an improved combustion air inlet passageway.

FIG. 9 shows a cross-sectional view taken at line 9-9 of FIG. 7, indicating the cross-sectional shape at the noted location of an improved combustion air inlet passageway.

FIG. 10 shows a cross-sectional view taken at line 10-10 of FIG. 7, indicating the cross-sectional shape at the noted location of an improved combustion air inlet passageway.

FIG. 11 shows a cross-sectional view taken at line 11-11 of FIG. 7, indicating the cross-sectional shape at the noted location of an improved combustion air inlet passageway.

FIG. 12 shows a perspective view, taken at 12-12 of FIG. 7, indicating the view at the noted location of the outlet of an improved combustion air inlet passageway, as well as the shape of the visible upstream portions of the air inlet passageway.

FIG. 13 shows a partial cross-sectional view of an aircraft engine cylinder jug, taken transversely through the head portion such as through line 13-13 of FIG. 2, showing a portion of the cylinder and cylinder head, and the hot exhaust gas outlet passageway, with various cross-sections noted, as depicted in FIG. 15, FIG. 16, FIG. 17 and FIG. 18, and the location of an upward view of the exhaust valve seat area and downstream combustion gas outlet passageway as shown in FIG. 14.

FIG. 14 shows a perspective view, taken at 14-14 of FIG. 13, indicating the view at the noted location and direction of the outlet of an improved hot exhaust gas outlet passageway, and also indicating the shape of the visible downstream portions of the hot exhaust gas outlet passageway.

FIG. 15 shows a cross-sectional view taken at line 15-15 of FIG. 13, indicating the cross-sectional shape at the noted location of an improved hot exhaust gas outlet passageway in an aircraft engine cylinder head.

FIG. 16 shows a cross-sectional view taken at line 16-16 of FIG. 13, indicating the cross-sectional shape at the noted location of an improved hot exhaust gas outlet passageway in an aircraft engine cylinder head.

FIG. 17 shows a cross-sectional view taken at line 17-17 of FIG. 13, indicating the cross-sectional shape at the noted location of an improved hot exhaust gas outlet passageway in an aircraft engine cylinder head.

FIG. 18 shows a cross-sectional view taken at line 18-18 of FIG. 13, indicating the cross-sectional shape at the noted location of an improved hot exhaust gas outlet passageway in an aircraft engine cylinder head.

FIG. 19 provides a side perspective view of an embodiment of an aircraft cylinder head of the type just set forth in FIGS. 1 and 2 above, now showing the intake flange in detail, and indicating the reduced flow cross-sectional area (at the intake flange) of the combustion air inlet passageway, as compared to the prior art passageway shape as set forth in broken lines, as well as showing typical cooling flanges on the adjacent portions of the cylinder head.

FIG. 20 provides a side perspective view of an embodiment of an aircraft cylinder head of the type just set forth in FIGS. 1 and 2 above, now showing the exhaust flange in detail, and indicating the reduced flow cross-sectional area (at the exhaust flange) of the hot exhaust gas outlet passageway, as compared to the prior art passageway shape as set forth in broken lines.

FIG. 21 is a partial cross-section view through an embodiment of an aircraft cylinder head, similar to that first shown in FIG. 1 above, but now showing an angled valve design, and wherein the cylinder head is provided in a more hemispherical shape, and showing the cylinder head including a portion of a combustion air inlet passageway in which gas flow has been enhanced by shaping the passageway, an intake valve and associated intake valve guide, the intake valve seat, the upper reaches of the combustion chamber within the cylinder jug, the exhaust valve seat, the exhaust valve with associated exhaust valve guide, and showing a portion of the hot exhaust exit outlet passageway in which gas flow has been enhanced by shaped passageways.

FIG. 22 is a conceptual view through an embodiment of an aircraft cylinder and head assembly, showing the relationship of the cylinder bore diameter, and the stroke of a piston operating in the cylinder, which together determine the swept displacement volume for the cylinder.

FIG. 23 is a partial cross-sectional view of an aircraft engine cylinder jug, taken transversely through the head portion such as through line 7-7 of FIG. 2, showing a portion of the cylinder and cylinder head, and the combustion air inlet passageway, including cross-sectional views of the intake valve seat and associated passageways, and the location of the intake valve seat area as further depicted in FIG. 24 below.

FIG. 24 is a partial cross-sectional view of an intake valve seat for an aircraft engine cylinder jug, taken transversely as if located in a cylinder head, showing the angles and relationships of various portions of the intake valve seat which are shaped to provide a smoothly dimensioned intake valve seat to minimize losses, and thus enhance engine performance.

FIG. 25 shows a partial cross-sectional view of an aircraft engine cylinder jug, taken transversely through the head portion such as through line 13-13 of FIG. 2, showing a portion of the cylinder and cylinder head, and the hot exhaust gas outlet passageway, with various cross-sections noted above, and further showing the location of a novel exhaust valve seat area as further depicted in FIG. 26 below.

FIG. 26 is a partial cross-sectional view of an exhaust valve seat for an aircraft engine cylinder jug, taken transversely as if located in a cylinder head, showing the angles and relationships of various portions of the exhaust valve seat which are shaped to provide a smoothly dimensioned exhaust valve seat to minimize losses, and thus enhance engine performance.

FIG. 27 provides a side perspective view of an embodiment of an aircraft cylinder head of the type just set forth in FIGS. 1 and 2 above, now showing the intake flange and the exhaust flange in detail, and indicating the reference point for dimensional data shown in TABLE 3 with respect to the intake valve, at sections as indicated in FIG. 28 below, and also indicating the reference point for dimensional data shown in TABLE 4 with respect to the exhaust valve, at sections as indicated in FIG. 29 below.

FIG. 28 shows a cross-sectional view taken at line 28-28 of FIG. 27, indicating the cross-sectional location of the shape described in TABLE 3 at the noted section location for an improved combustion air inlet passageway.

FIG. 29 shows a cross-sectional view taken at line 29-29 of FIG. 27, indicating the cross-sectional location of the shape described in TABLE 4 at the noted section location for an improved hot exhaust gas outlet passageway in an aircraft engine cylinder head.

FIG. 30 is a cross-sectional view of an inlet valve seat insert for an aircraft engine cylinder head, taken transversely as if located in a cylinder head, showing the use of a smooth radiused inlet valve inlet throat, and the relationships of various portions of the inlet valve seat insert which are shaped to provide a smoothly dimensioned inlet valve seat to minimize losses, and thus enhance engine performance.

FIG. 31 is a cross-sectional view of an exhaust valve seat insert for an aircraft engine cylinder head, taken transversely as if located in a cylinder head, showing the use of a smooth radiused exhaust valve outlet throat, and the relationships of various portions of the exhaust valve seat insert which are shaped to provide a smoothly dimensioned exhaust valve seat to minimize losses, and thus enhance engine performance.

In the drawing figures, like features may be illustrated with the same reference numerals, without further mention thereof. The drawing figures are merely exemplary, and may contain various elements that might be present or omitted from actual implementations of certain embodiments. An attempt has been made to draw the figures in a way that illustrates at least those elements that are significant for an understanding of the invention. However, the drawings are generalized in the interest of clarity and conciseness. Other elements or components for an improved inlet passageway, exhaust gas exit passageway, and valve seats, may be utilized to provide useful performance enhancing components for aircraft engines, while within the scope and coverage of the claims set forth herein, or legal equivalents thereof.

### DETAILED DESCRIPTION

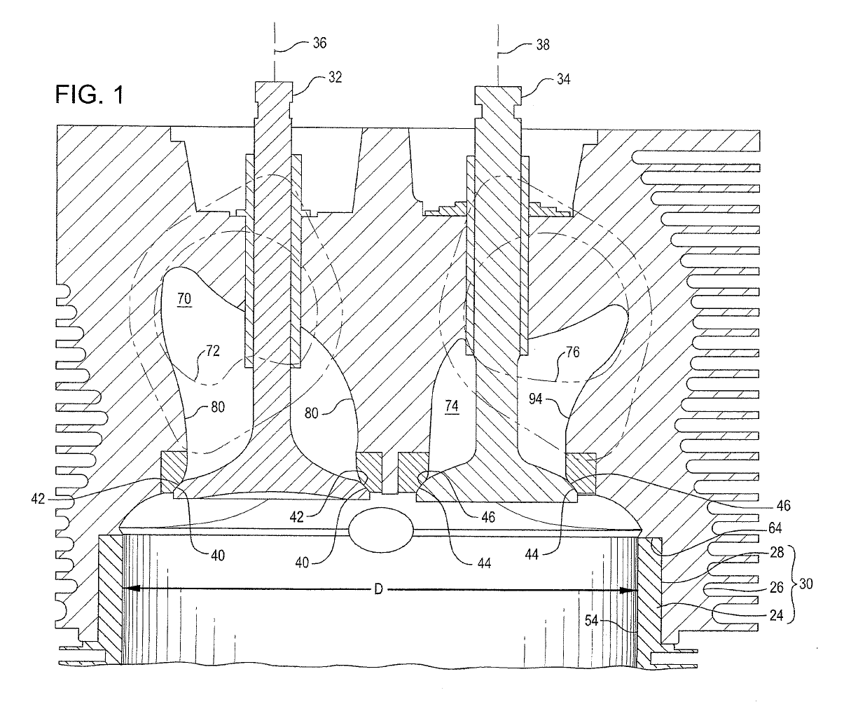

Attention is directed to FIG. 1, which illustrates a cylinder portion 24 and a head portion 26 which may be joined such as at joint 28 to provide a cylinder and head assembly 30 for an aircraft engine (not shown in its entirety). In various engine configurations, engine manufacturers may provide the cylinder potion 24 and the head portion 26 as a cylinder and head assembly (e.g. in the Lycoming Model O-360-C1G Parts Catalog as Part Number LW-12427, the “CYLINDER AND HEAD ASSY., Nitrided”). Alternately, the head portion 26 may be provided as a separate part from the cylinder itself. Those of skill in the art will recognize that the improvements described herein are described for use in the head portion 26, regardless of whether a head portion is provided separately, or as part of a combined cylinder and head assembly 30. Consequently, it should be understood that references to the “head” shall refer to the “head portion 26” regardless of whether or not a head is provided independently, or as a head portion of a cylinder and head assembly 30, unless otherwise noted or made clear by context. However, various alternatives for parts supply including the inventive concepts described herein are set forth in this specification, including (a) the provision of a combined cylinder and head assembly 30, and (b) the provision of a separable cylinder head or cylinder head portion 26 alone, wherein the cylinder head portion 26 is configured for attachment to a cylinder portion 24.

In the embodiment shown in FIG. 1, a parallel valve arrangement is provided, in that the intake valve 32 and the exhaust valve 34 are arranged in parallel fashion along their respective operative longitudinal axes 36 and 38, respectively. Intake valve 32 has an intake valve seating face 40 that acts in concert with intake valve seat surface 42 to seal the intake during engine compression and exhaust cycles. Similarly, exhaust valve 34 has an exhaust valve seating face 44 that acts in concert with exhaust valve seat surface 46 to seal the exhaust valve during engine intake and compression cycles. Both the intake valve 32 and the exhaust valve 34 are operable in conventional fashion, and in conventional design configurations except as otherwise noted herein.

As shown in the schematic view provided at FIG. 22, a cylinder and head assembly 30 for use on an aircraft engine is provided. The cylinder portion 24 includes a cylinder body 50, having a cylinder bore 52 of diameter D, defined by inner sidewall 54. The cylinder bore 52 is configured to operably confine a piston 56 of selected stroke distance 58 (i.e. operation is between top dead center 60 and bottom dead center 62), and thereby define a swept displacement volume DV.

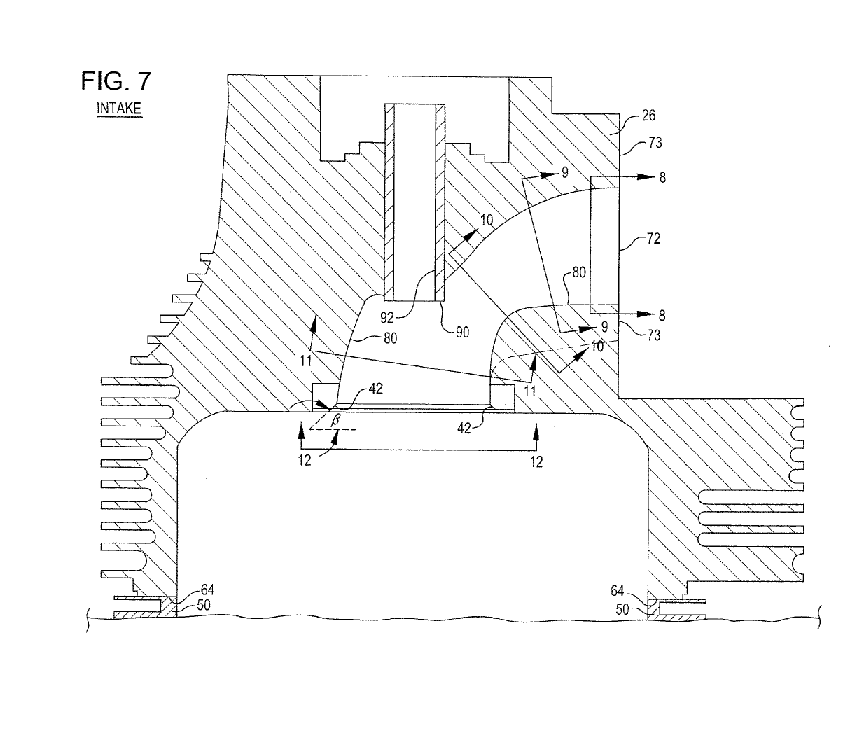

As seen in FIG. 1 and in FIG. 7, adjacent the outer end 64 of cylinder body 50, a head portion 26 is provided. The head portion 26 includes an inlet passageway 70 extending between an upstream inlet 72 and the intake valve seat surface 42. At upstream inlet 72, a flat intake gasket face 73 may be provided, and in an embodiment, in conventional fashion. The head portion 26 also includes an exhaust passageway 74 extending between an exhaust valve seat surface 46 and an exhaust outlet 76. At exhaust outlet 76, a flat exhaust gasket face 77 may be provided, and in an embodiment, in conventional fashion.

The inlet passageway 70 has inlet passageway sidewalls 80 that cooperate to define, between the upstream inlet 72 and the intake valve seat surface 42, an inlet passageway volume IPV for the inlet passageway 70. In an embodiment, the inlet passageway volume IPV may be about thirty percent (30%), or less, of the swept displacement volume DV as described above. In ah embodiment, the inlet passageway volume IPV may be about twenty-eight percent (28%), or less, of the swept displacement volume DV. In an embodiment, the inlet passageway volume IPV may be about twenty-five percent (25%) or less, of the swept displacement volume DV.

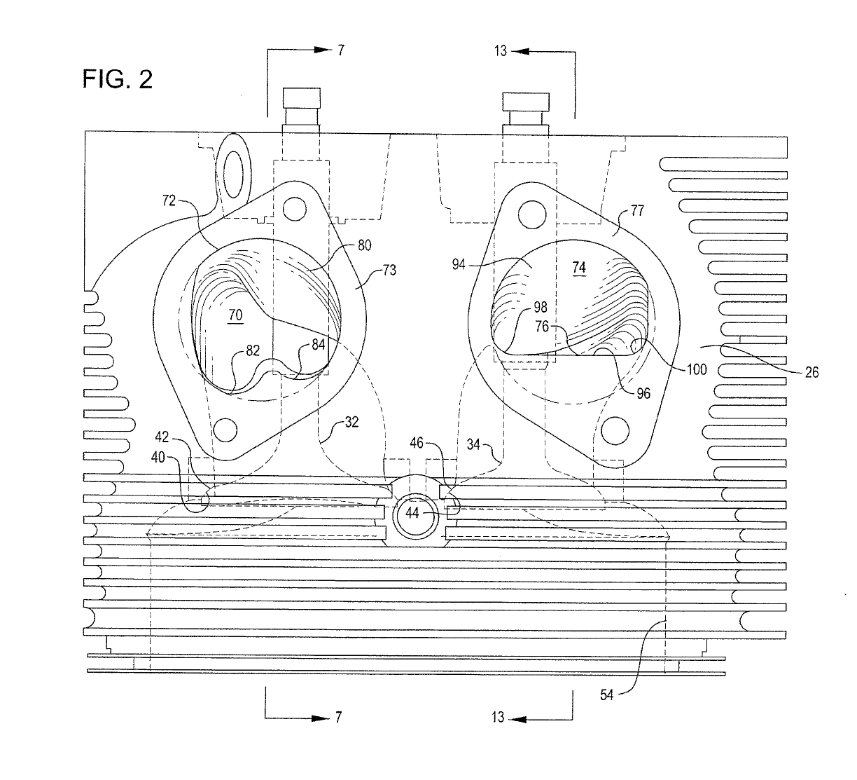

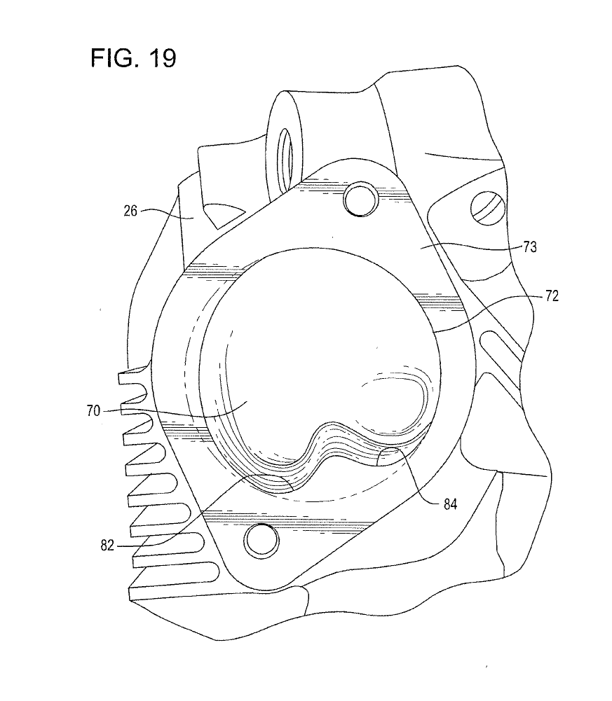

As better seen in FIG. 2, in an embodiment, at the upstream inlet 72, the inlet passageway 70 may be provided having in cross-section, a kidney shape, with the kidney shape having a first lobe 82 and a second lobe 84. Further, as seen in FIG. 2, and also as clearly set forth in FIG. 19, the first lobe 82 and the second lobe 84 may be of uneven size.

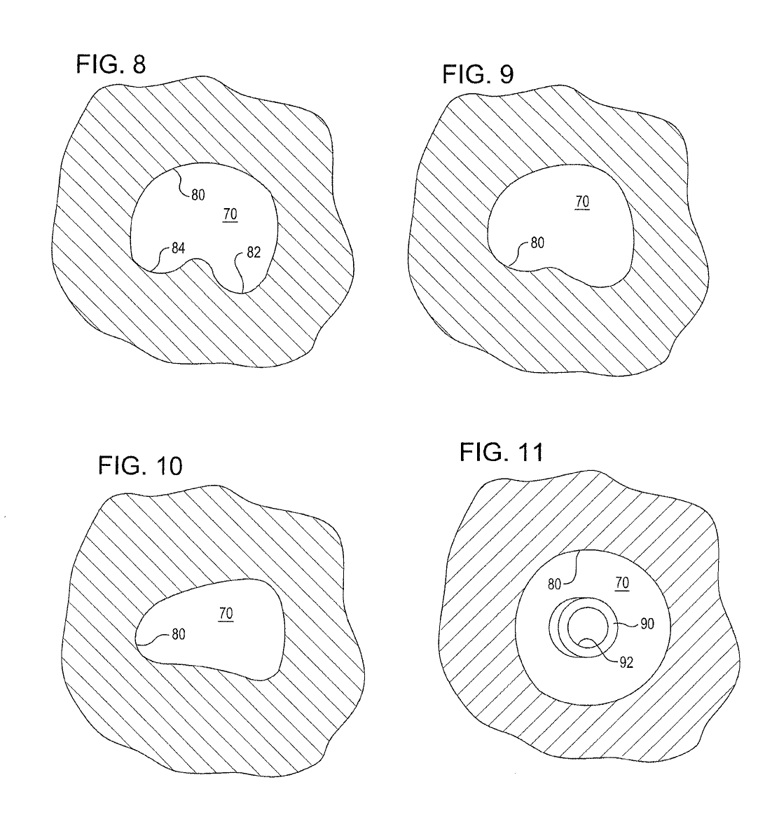

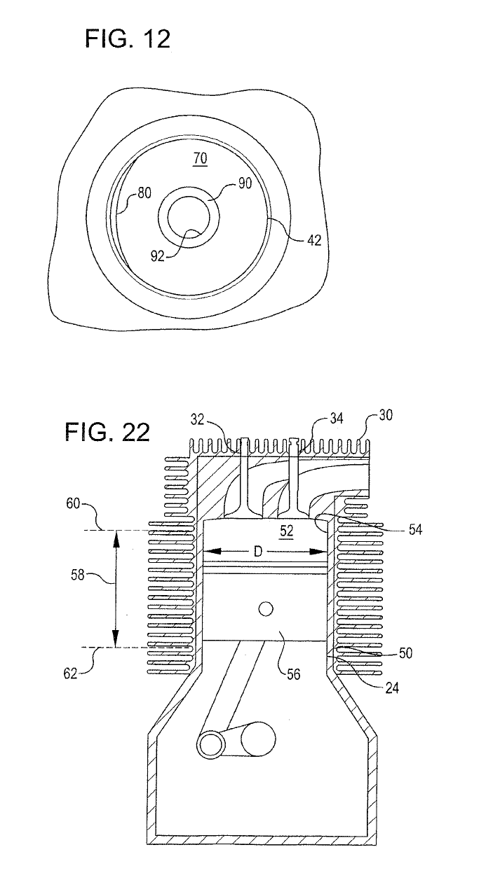

As may be seen FIGS. 7, 8, 9, 10, 11, and 12, the inlet passageway sidewalls 80 may be provided in a cross-sectional shape corresponding to a surface reflecting the shapes at one or more of the cross-section locations as set forth in FIG. 7 and as described by the illustrations of such cross-section shape as set forth in FIG. 8, FIG. 9, FIG. 10, and FIG. 11. Further, in an embodiment, the inlet passageway sidewalls 80 may be provided in a cross-sectional shape having a curve fitted surface corresponding, at the intake valve seat surface 42, to the shape set forth in FIG. 12. Further, in an embodiment, the inlet passageway sidewalls 80 may comprise, in cross-sectional shape, a curve-fitted shaped surface corresponding to the cross-sectional shapes shown at the cross-section locations noted in FIG. 7 as illustrated in FIGS. 8, 9, 10, and 11. In an embodiment, the cross-sectional shape at any one or more of the cross-sectional locations noted in FIG. 7 may be as if taken orthogonally with respect to a centerline of the inlet passageway 70. In further detail as indicated in FIGS. 11 and 12, the bottom end 90 of intake valve guide 92 may also be seen.

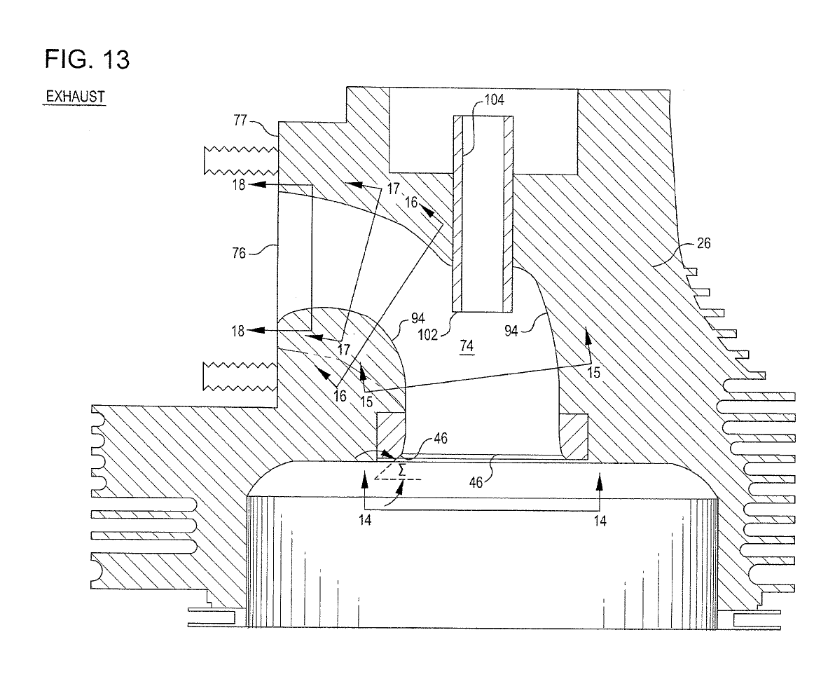

Turning now to FIG. 13, the exhaust passageway 74 has exhaust passageway sidewalls 94 to define, between the exhaust valve seat surface 46 and the exhaust outlet 76, an exhaust passageway volume EPV. In an embodiment, the exhaust passageway volume EPV may be sized to provide about seventy-five percent (75%), or less, of the gas flow rate through the inlet passageway, when measured at equivalent pressure drop, as compared to an inlet passageway having the inlet passageway volume IPV as described above. When the inlet passageway volume IPV is varied, in various embodiments, the ratio of exhaust passageway volume EPV to the inlet passageway volume IPV may remain sized to provide about seventy-five percent (75%) or less, of the gas flow rate through the inlet passageway, when measured at equivalent pressure drop, as compared to the corresponding inlet passageway volume IPV.

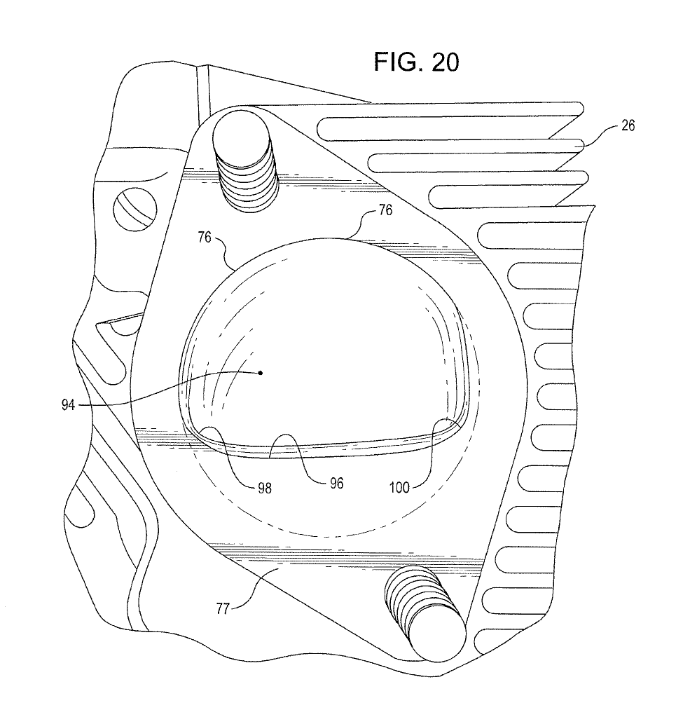

As seen in FIGS. 2 and 20, at the exhaust outlet 76 (and as shown in FIG. 18, extending for a distance upstream from exhaust outlet 76) the exhaust passageway 74 may have, in an embodiment, a stylized-D cross-sectional shape. As more clearly seen in FIG. 20, in an embodiment, the stylized-D shape may further include a relatively flat portion 96 having rounded corners 98 and 100.

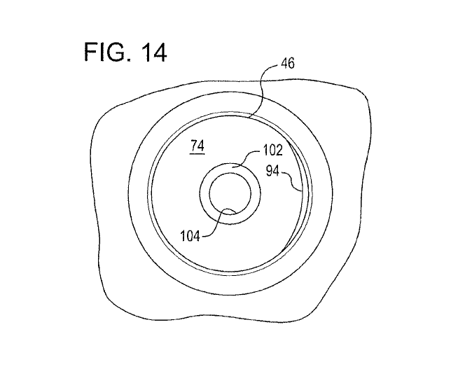

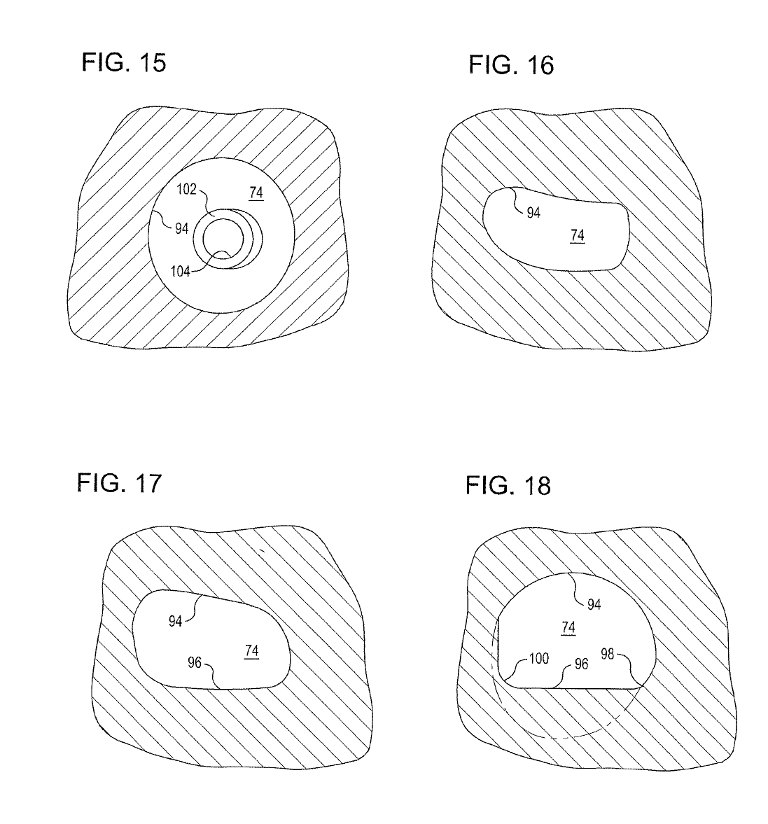

As may be appreciated from FIGS. 13, 14, 15, 16, 17, and 18, in an embodiment, the exhaust passageway sidewalls 94 may be provided having a cross-sectional shape corresponding to a curve-fitted surface corresponding to one or more of the cross-section locations as set forth in FIG. 15 and corresponding to the cross-sectional shapes illustrated in FIGS. 15, 16, 17, and 18. In an embodiment, such cross-sectional shapes as illustrated in FIGS. 15, 16, 17, and 18, may correspond to a cross section taken orthogonal to a centerline of exhaust passageway 74. In an embodiment, the exhaust passageway sidewalls 94 may have, in cross-section shape, a curve fitted surface corresponding to a view of the exhaust valve seat surface 46 as set forth in FIG. 14. In an embodiment, the exhaust passageway sidewalls 94 may be provided having a cross-sectional shape corresponding to a curve-fitted surface corresponding to each of the cross-sectional shapes as illustrated in FIGS. 15, 16, 17, and 18, for the corresponding cross-section locations as set forth in FIG. 15. In further detail as indicated in FIGS. 14 and 15, the bottom end 102 of exhaust valve guide 104 may also be seen.

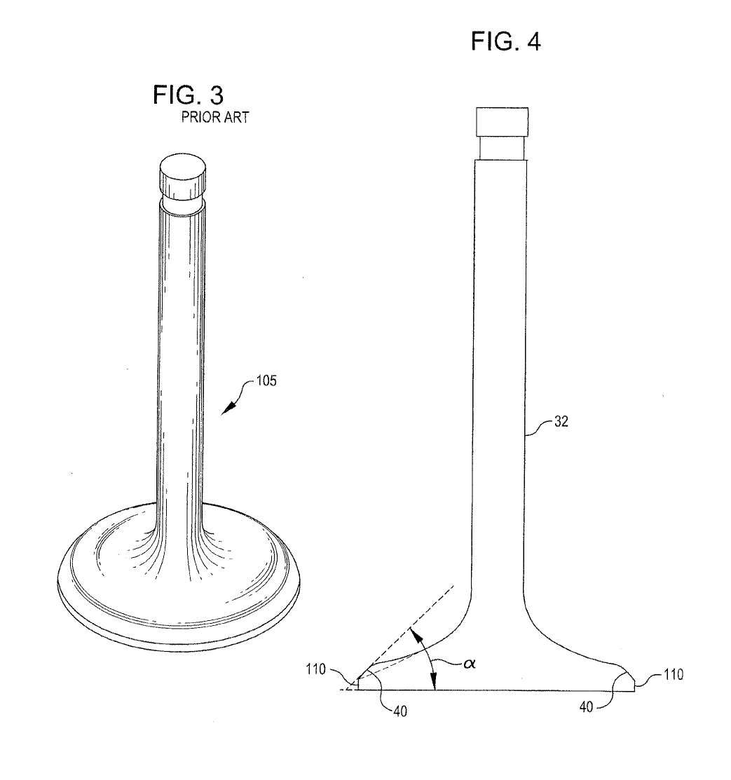

In order to further increase the performance of an engine utilizing the designs taught herein, additional refinements may be made to the configuration of intake valve 32, and more particularly, the configuration of the intake valve seating face angle alpha (α), as noted in FIG. 4. As generally illustrated in FIG. 3, a prior art intake valve 105 might be provided with an intake valve seating face of about thirty degrees (30°). As more particularly shown in FIG. 4A, a prior art intake valve such as the valve 105 shown in FIG. 3 might have been provided having a seat face angle alpha (α) of about thirty degrees (30°) (as also indicated for reference in FIG. 4A along broken line 106, for comparison to my current design configuration). However, I have found that adjustment of the intake valve seat face angle alpha (α) to about forty-five degrees (45°), as indicated along broken line 108, reduces directional change required for the air traversing the inlet passageway 70, thus reducing the pressure loss through the inlet passageway 70. More particularly, I have found that providing an intake valve 32 with an intake valve seating face 40 of length L₄₀ that is oriented at an angle alpha (α) of about forty-five degrees (45°), plus or minus about three, degrees (3°), provides improved performance, as more fully explained elsewhere herein. In an embodiment, I have found that performance may be optimized by using an intake valve seating face 40 having an angle alpha (α) of about forty-five degrees) (45°), plus or minus about one point five degrees (1.5°). Of course, as noted in FIG. 7, in any of such embodiments as just described, the intake valve seat surface 42 should be oriented at an angle beta (β) complimentary to the angle alpha (α) of the intake valve 32 intake valve seating face 40. Other details for a suitable intake valve 32 may be specified in a conventional manner, such as the radius R32, and the intake valve margin 110 height H₃₂.

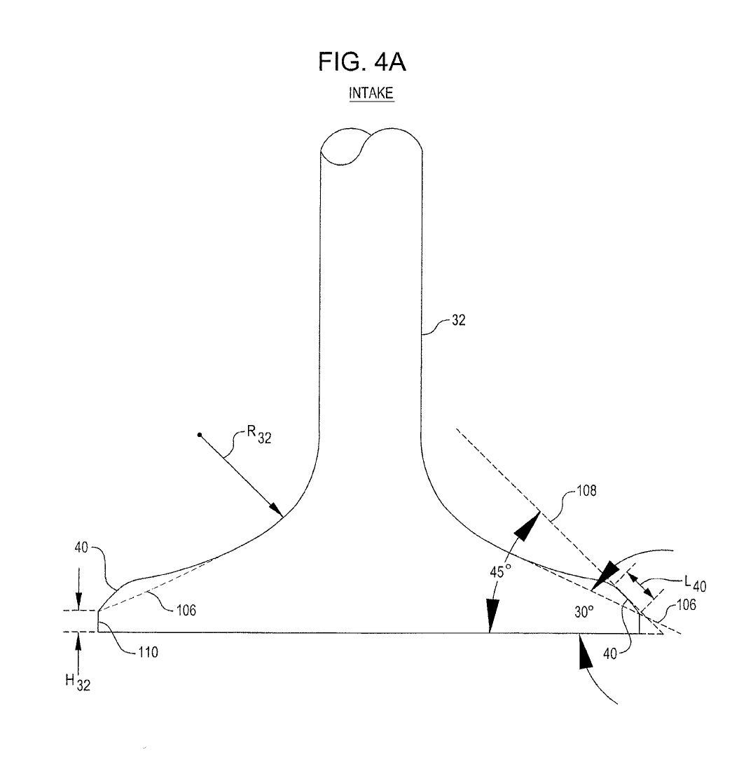

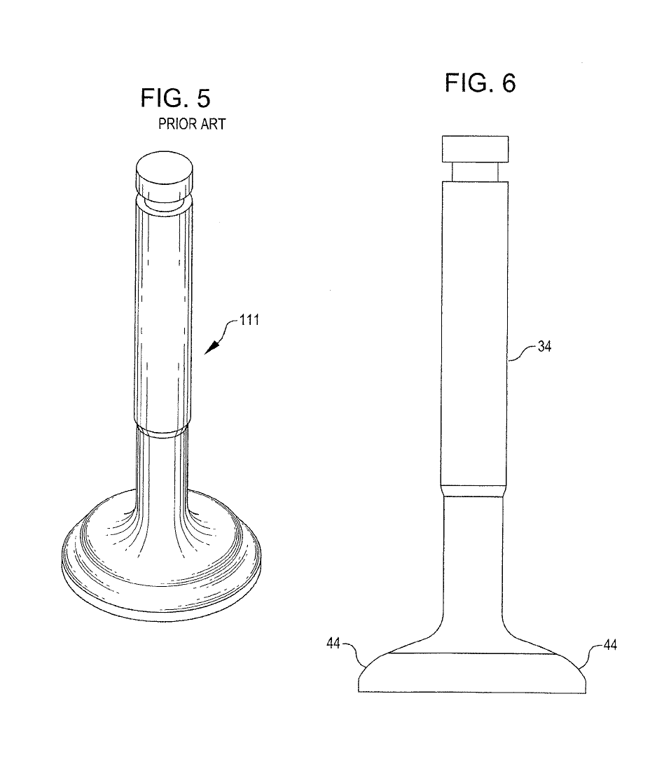

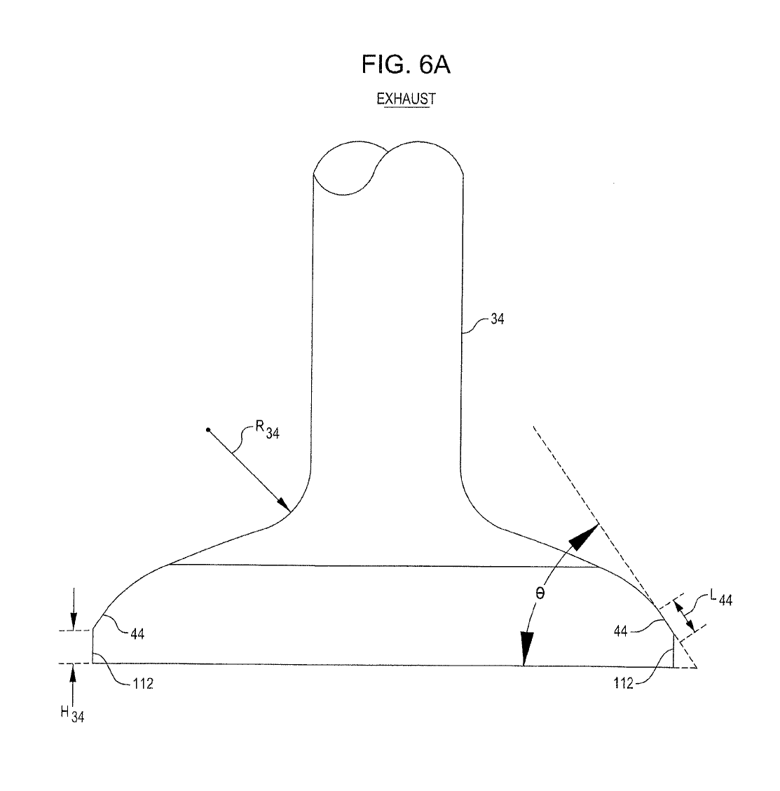

In order to provide yet further increase in the performance of an engine utilizing the designs taught herein, additional refinements may be made to the configuration of exhaust valve 34, and more particularly, to the configuration of the exhaust valve seating face 44. In an embodiment, an exhaust valve seating face 44 may be provided having a length L₄₄ and disposed at an exhaust valve seating face 44 angle theta (θ), as noted in FIG. 6A. As generally indicated in FIG. 5, a prior art exhaust valve 111 may be provided with a exhaust valve seating face angle of about thirty degrees (30°). In an embodiment, as noted in FIG. 6A, the exhaust valve seating face 44 of an exemplary exhaust valve 34 may be oriented at an angle theta (θ) of about forty-five degrees (45°), plus or minus about three degrees (3°). The range for such an angle theta (θ) is of course from about forty-two degrees (42°) to about forty-eight degrees (48°). In an embodiment, the exhaust valve seating face 44 may be oriented at an angle theta (θ) of about forty-five degrees (45°), plus or minus about one point five degrees (1.5°). The range for such an angle theta (θ) is of course from about forty-three point five degrees (43.5°), to about forty-six point five degrees (46.5°). As noted in FIG. 13, in any of such embodiments as just described, the exhaust valve seat surface 46 should be oriented at an angle sigma (Σ) complimentary to the angle theta (θ) of the exhaust valve seating face 44. Other details for a suitable exhaust valve 34 may be specified in a conventional manner, such as the exhaust valve radius R₃₄, and the exhaust valve margin 112 height H₃₄.

As mentioned above, in FIG. 1, the intake valve 32 and exhaust valve 34 may, in an embodiment, be oriented for parallel valve operation, wherein the operational longitudinal centerline 36 of the intake valve 32 and the operational longitudinal centerline 38 of the exhaust valve 34 are parallel. In such an embodiment, the intake valve seat surface 42 and the exhaust valve seat surface 46 are accordingly configured and located for parallel valve operation.

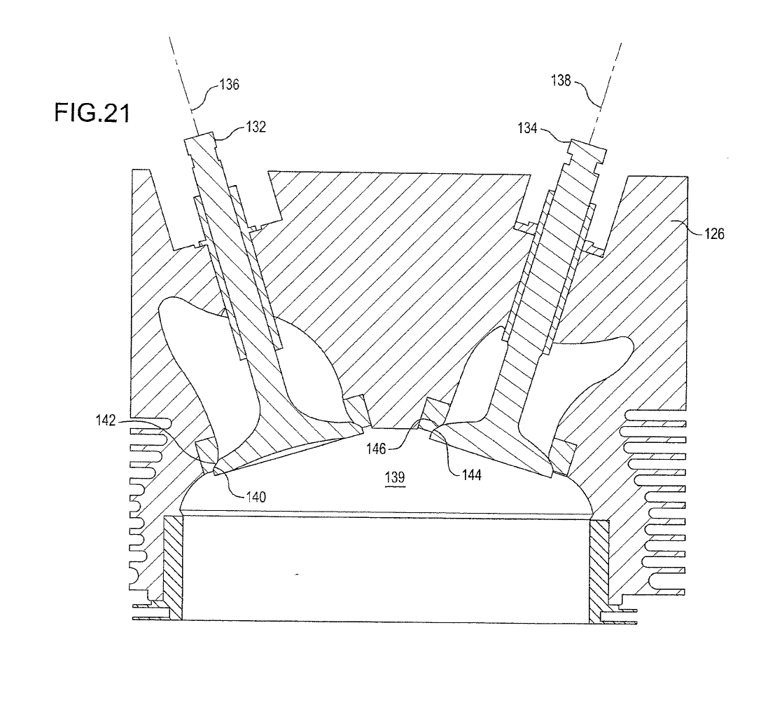

Alternately, as illustrated in FIG. 21, in an embodiment, a head portion 126 may be configured using an intake valve 132 and an exhaust valve 134 in an angled valve configuration, wherein the operational longitudinal axis 136 of the intake valve 132, and the operational longitudinal axis 138, of the exhaust valve 134, are not parallel, but angled, in the outward direction, away from each other, thus allowing additional combustion space volume 139 above a cylinder (not shown). Thus, in such a configuration, the intake valve seat surface 142 (adjacent the intake valve seating face 140) and the exhaust valve seat surface 146 (adjacent the exhaust valve seating face 144) are configured for such angled valve operation.

A series of performance tests were conducted on a test bench, using air flow measurements (cubic feet per minute—“cfm”) on a static test piece which had been modified. Table 1.1 shows a set of baseline measurements conducted on a standard, stock Lycoming engine head. Then, inlet passageway 70 of the Lycoming head was modified, and performance at various flow conditions was measured. As noted in Table 1.2, modification of the inlet passageway 70 alone as described herein may be anticipated to provide an average gain of 3.36 horsepower, and a peak gain of 5.74 horsepower, for a typical Lycoming nominal 180 horsepower engine (of nominal 360 cubic inch displacement). For the same engine, when intake valve 32 (or 132) improvements are additionally provided, an average gain of 5.32 horsepower may be expected, and a peak gain of 8.19 horsepower is anticipated. Addition of improved intake valve seats and exhaust valve seats may further improve performance.

Similarly, air flow bench testing was conducted on a test head portion having a modified exhaust passageway 74. As noted in Table 2.1, a baseline set of measurements was conducted. Then, the Lycoming head portion 26 was evaluated after modification of the exhaust passageway 74, and performance at various flow conditions was evaluated. With just modifications to the exhaust passageway 74, an average horsepower gain of four percent (4%) is expected, and a peak horsepower gain of six percent (6%). For the same head portion with additional modifications to the exhaust valve 34, average HP gain of ten percent (10%) is expected, and a peak gain of fourteen percent (14%).

In addition to the use of head portion 26, or cylinder and head assembly 30, as explained above, in a new aircraft engine, the various components described herein may be utilized in retrofit or the rebuilding of existing aircraft engines, in order to increase performance thereof. Candidate engines for such a retrofit may be found in aircraft designed for use with an existing air cooled spark ignited piston engine with an original rated maximum horsepower, and where the engine have a plurality of individual cylinders each having cylinder head portions, and where the existing piston engine is mechanically designed for operation by intake of combustion air through original inlet air passageways in the cylinder head portions, providing an air fuel mixture to the individual cylinders, and combusting the fuel to produce hot exhaust gases that exit through original exhaust passageways in the cylinder head portions. An improvement in performance may be obtained by substituting, the existing cylinder head portions with replacement cylinder head portions 26, wherein the replacement cylinder head portions 26 each providing an enhanced inlet air passageway 70 having reduced pressure drop during passage of combustion air therethrough as compared to pressure drop during passage of said combustion air through original air inlet passageways. Consequently, the use of the replacement cylinder head portions 26 provide an enhanced rated horsepower in excess of the original rated maximum horsepower for such an engine.

In addition to providing an enhanced inlet passageway 70 in such replacement head portion 26 (or 126), an enhanced exhaust passageway 74 may be provided, having reduced pressure drop during passage of exhaust gases therethrough as compared to passage of hot exhaust gases through an original exhaust passageway. The use of such a replacement cylinder head portion 26, or a cylinder and head assembly 30, as appropriate given a particular engine design or retrofit requirement, provides an enhanced rated horsepower in excess of the original rated maximum horsepower.

TABLE 1.1
INTAKE: Stock Lycoming Head + Stock Lycoming Valve

| Valve Lift (in.) | % of Reference¹ | Flow (CFM) | BASELINE |
|---|---|---|---|
| 0.200 | 48 | 91.46 | |
| 0.250 | 52 | 99.09 | |
| 0.300 | 56 | 106.75 | |
| 0.350 | 60 | 114.33 | |
| 0.400 | 63 | 120.05 | |
| | | Avg = 106.33 | |

¹ Bench test reference of 190.55 cfm at 10 inches of water pressure at the upstream inlet to the inlet passageway. Same for each of Table 1.1, Table 1.2, and Table 1.3.

TABLE 1.2
INTAKE: Modified Lycoming Head + Stock Lycoming Valve

| | | Flow | | HP |
|---|---|---|---|---|
| Valve Lift (in.) | % of Reference | (CFM) | Improvement | GAIN |
| 0.200 | 47 | 89.56 | | |
| 0.250 | 54 | 102.90 | | |
| 0.300 | 61/5 | 117.19 | | |
| 0.350 | 67 | 127.67 | | |
| 0.400 | 70 | 133.39 | Peak Gain | 5.74 HP |
| | | Avg = 114.14 | Avg. Gain | 3.36 HP |

TABLE 1.3
INTAKE: Modified Lycoming Head + Modified Valve

| | | Flow | | HP |
|---|---|---|---|---|
| Valve Lift (in.) | % of Reference | (CFM) | Improvement | GAIN |
| 0.200 | 46 | 89.56 | | |
| 0.250 | 56.5 | 102.90 | | |
| 0.300 | 65.5 | 117.19 | | |
| 0.350 | 70.5 | 127.67 | | |
| 0.400 | 73 | 133.39 | Peak Gain | 8.19 HP |
| | | Avg = 118.71 | Avg. Gain | 5.32 HP |

TABLE 2.1
EXHAUST: Stock Lycoming Head + Stock Lycoming Valve

| Valve Lift (in.) | % of Reference² | Flow (CFM) | BASELINE |
|---|---|---|---|
| 0.200 | 32 | 60.98 | |
| 0.250 | 40 | 76.22 | |
| 0.300 | 45 | 85.75 | |
| 0.350 | 47 | 89.56 | |
| 0.400 | 50 | 95.28 | |
| | | Avg = 81.56 | |

² Same baseline reference for each of Table 2.1, Table 2.2, and Table 2.3.

TABLE 2.2
EXHAUST: Modified Lycoming Head + Stock Valve

| Valve Lift (in.) | % of Reference | Flow (CFM) | Improvement | HP GAIN |
|---|---|---|---|---|
| 0.200 | 35 | 66.69 | | |
| 0.250 | 41 | 78.13 | | |
| 0.300 | 46 | 87.65 | | |
| 0.350 | 48 | 91.46 | | |
| 0.400 | 53 | 100.98 | Peak Gain | 6% |
| | | Avg = 84.98 | Avg. Gain | 4% |

TABLE 2.3
EXHAUST: Modified Lycoming Head + Modified Valve

| Valve Lift (in.) | % of Reference | Flow (CFM) | Improvement | HP GAIN |
|---|---|---|---|---|
| 0.200 | 35 | 66.69 | | |
| 0.250 | 42 | 80.03 | | |
| 0.300 | 49 | 93.37 | | |
| 0.350 | 54 | 102.90 | | |
| 0.400 | 58 | 110.52 | Peak Gain | 14% |
| | | Avg = 90.70 | Avg. Gain | 10% |

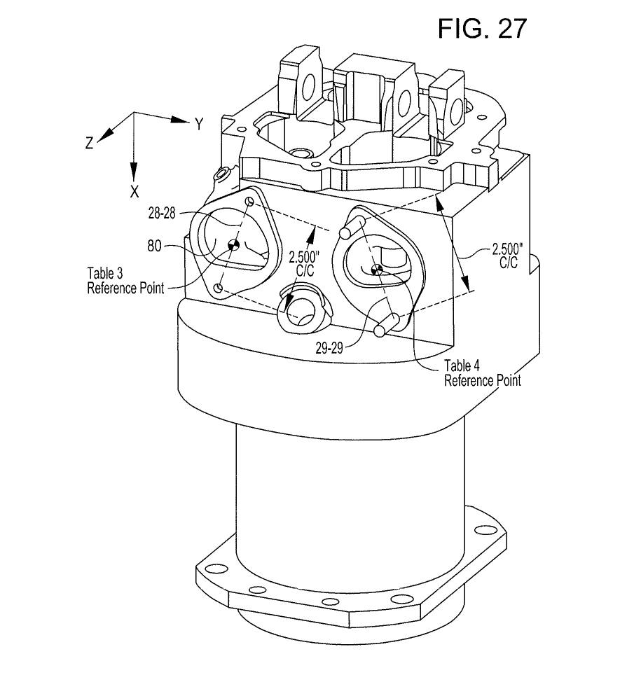

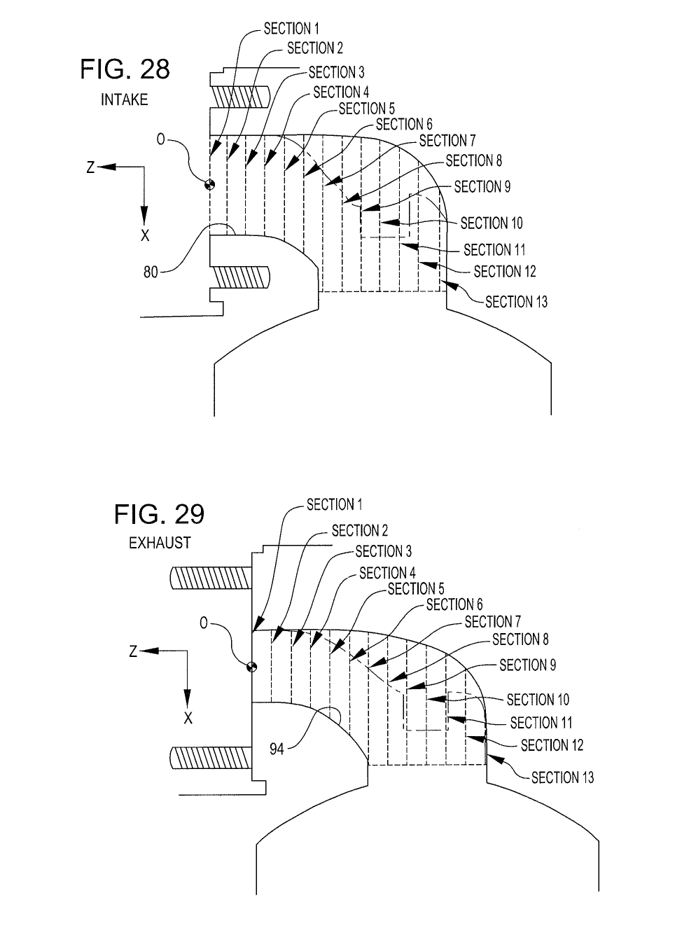

As may be seen from a view of FIGS. 27 and 28 when combined with the dimensional information set forth in Table 3, the inlet passageway sidewalls 80 may be provided in a cross-sectional shape corresponding to a surfaces reflecting the shapes at each of the cross-section locations as set forth in FIG. 28 with the dimensions provided by the Cartesian coordinate values in Table 3 ((X, Y, and Z coordinate height, depth, and width, in inches, from a point of origin for the internal coordinate system as shown in FIG. 27.). Further, in an embodiment, the inlet passageway sidewalls 80 may comprise a curve-fitted shaped surface corresponding to the cross-sectional shapes shown at the cross-section locations noted in FIG. 28, as more particularly described in Table 3. Further, in various embodiments the Cartesian coordinate values of X, Y and Z set forth in Table 3 may be scalable as a function of the same constant or number, so as to provide for dimensions of a cylinder head of a selected size having an inlet passageway of a selected inlet passageway volume.

As may be seen from a view of FIGS. 27 and 29, when combined with the dimensional information in Table 4, the exhaust passageway 74 has exhaust passageway sidewalls 94 may be provided in a cross-sectional shape corresponding to a surfaces reflecting the shapes at each of the cross-section locations as set forth in FIG. 29 with the dimensions provided by the Cartesian coordinate values in Table 4 ((X, Y, and Z coordinate height, depth, and width, in inches, from a point of origin for the internal coordinate system as shown in FIG. 27). Further, in an embodiment, the exhaust passageway sidewalls 94 may comprise a curve-fitted shaped surface corresponding to the cross-sectional shapes shown at the cross-section locations noted in FIG. 29, as more particularly described in Table 4. Further, in various embodiments the Cartesian coordinate values of X, Y and Z set forth in Table 4 may be scalable as a function of the same constant or number, so as to provide for dimensions of a cylinder head of a selected size having an exhaust passageway of a selected exhaust passageway volume.

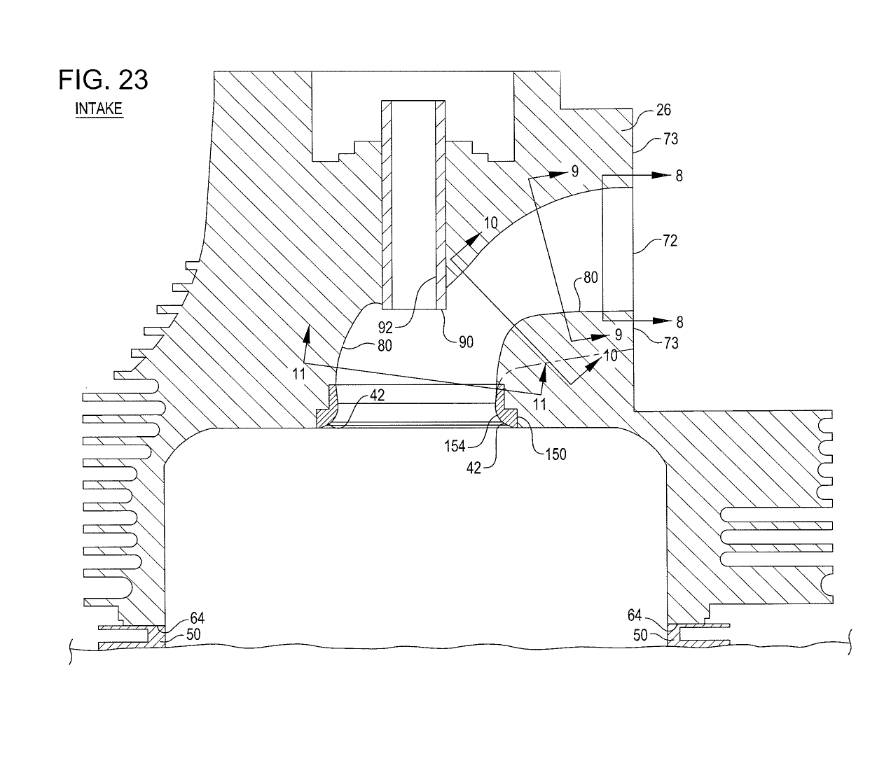

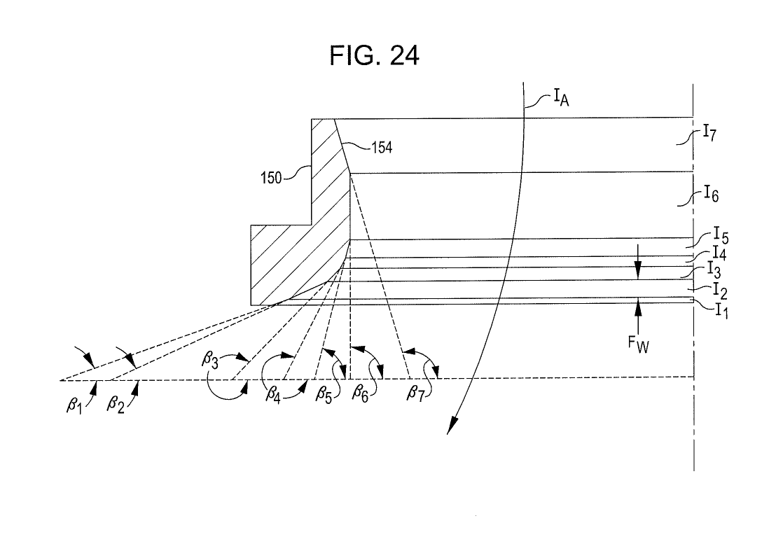

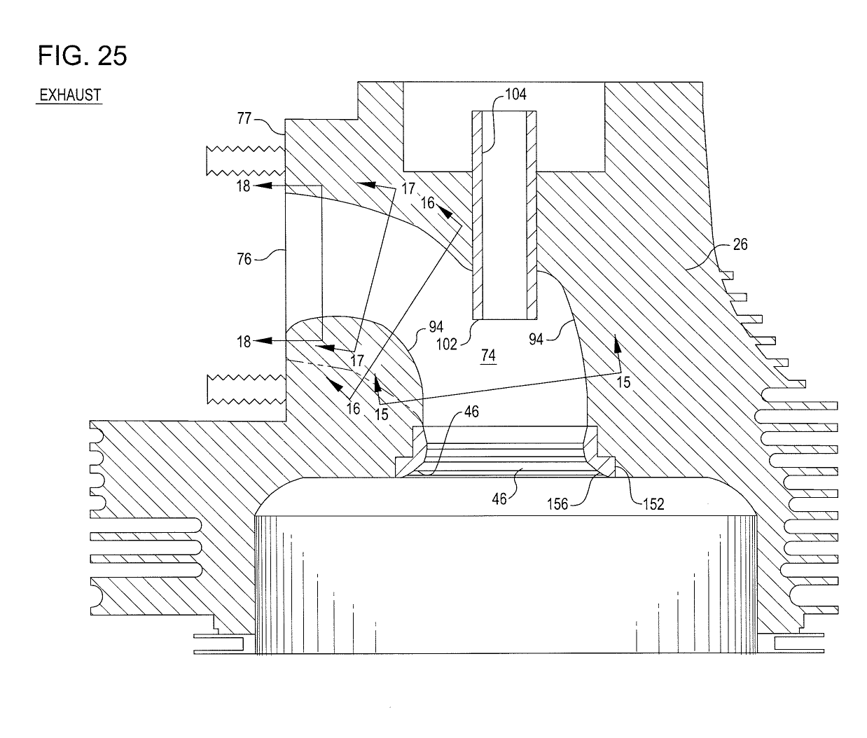

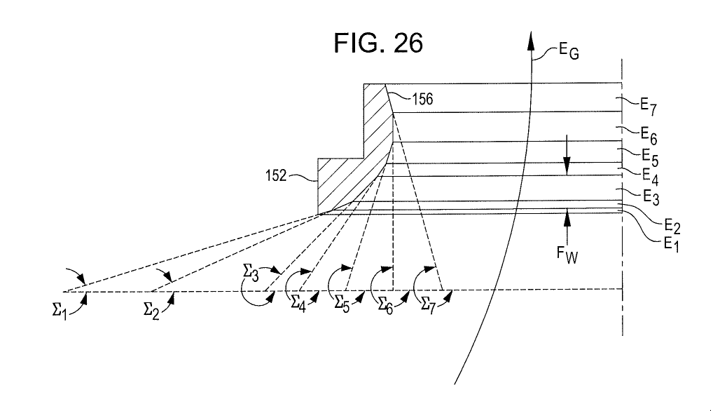

Yet further, improved inlet valve seats 150 (see FIGS. 23 and 24), and improved exhaust valve seats 152 (see FIGS. 25 and 26) may be provided to improve performance. A cylinder head 26 (or head 126 with angular configuration as seen in FIG. 21), is provided for attachment to a cylinder body having a cylinder bore of diameter defined by a sidewall, and an outer end, the cylinder bore configured to operably confine a piston of selected stroke distance, and with the piston thereby define a swept displacement volume DV, as described herein above. In an embodiment, the intake valve seats may be provided as inserts 150, as noted in FIGS. 23 and 24. In an embodiment, the exhaust valve seats may be provided as inserts 152, as noted in FIGS. 25 and 26. In an embodiment, the exhaust valve seats have exhaust valve seat sidewalls 156, which are configured for passage there through of exhaust gases.

In an embodiment, the intake valve seat inserts 150 have intake valve seat sidewalls 154, which are configured for passage there through of intake air. In an embodiment, the intake valve seat sidewalls 154 may be provided in cross-sectional shape as seen in FIG. 23, as an aerodynamically shaped surface having a plurality of intake valve seat facets respectively oriented at angles as defined at a respective cross-section location of each of the plurality of intake valve seat facets. For example, in an embodiment as shown in FIG. 24, the intake valve seat sidewalls 154 may comprise a shaped surface having a plurality of facets in an inlet airflow direction depicted by the airflow arrow identified by reference letter IA of I₇ I₆, I₅, I₄, I₃, I₂, and I₁, and, defined respectively by a set of decreasing angles, for example, an angle β₇ of about one hundred five degrees, β₆ of about ninety degrees, β₅ of about seventy-five degrees, β₄ of about sixty degrees, β₃ of about forty-five degrees, β₂ of about thirty degrees, and β₁ of about fifteen degrees. A few degrees of variations in the stated angles may achieve comparable results. In an embodiment, angle β₁ may be at about fifteen degrees (15°). In an embodiment, angle β₁ may be at about fifteen degrees (15°). In an embodiment, angle β₂ may be at about thirty degrees (30°). In an embodiment, angle β₃ may be at about forty-five degrees (45°). In an embodiment, angle β₄ may be at about sixty degrees (60°). In an embodiment, angle β₅ may be at about seventy-five degrees (75°). In an embodiment, angle β₆ may be at about ninety degrees (90°). In an embodiment, angle β₇ may be at about one hundred five degrees (105°).

For general description purposes, each facet may have an “in-plane” width described as its facet width F_{W}. In an embodiment the facet I₂ associated with the angle β₂ may have a facet width F_{W} of about zero point one two inches (0.12″).

In an embodiment, as seen in FIG. 24, the angle β₃ may be at about forty-five degrees (45°), and the angle β₄ may be at about sixty degrees (60°), and the angle β₅ is about seventy-five degrees (75°). In an embodiment, the facets I₃, I₄, I₅ associated with angles β₃, β₄, and β₅ respectively, may be of approximately equal facet width F_{W}.

In an embodiment, the intake valve seat sidewalls 154 may be configured, in cross-sectional shape, as a curve-fitted shaped surface corresponding approximately to the facets I₁, I₂, I₃, I₄, I₅, I₆, or I₇, respectively defined by one or more of the angles β₁, β₂, β₃, β₄, β₅, β₆, or β₇, all as noted above, at the respective cross-section locations as set forth in FIG. 24. In an embodiment, the intake valve seat sidewalls 154 may be configured, in cross-sectional shape, as a curve-fitted shaped surface corresponding to shapes defined by each of the angles β₁, β₂, β₃, β₄, β₅, β₆, or β₇, at each of the respective cross-section locations as set forth in FIG. 24. In an embodiment, the intake valve seat sidewalls 154 may be configured as a smooth curve fitted surface corresponding approximately to the facet surfaces defined by the series of angles β₁, β₂, β₃, β₄, β₅, β₆, or β₇, at the respective cross-section locations as set forth in FIG. 24.

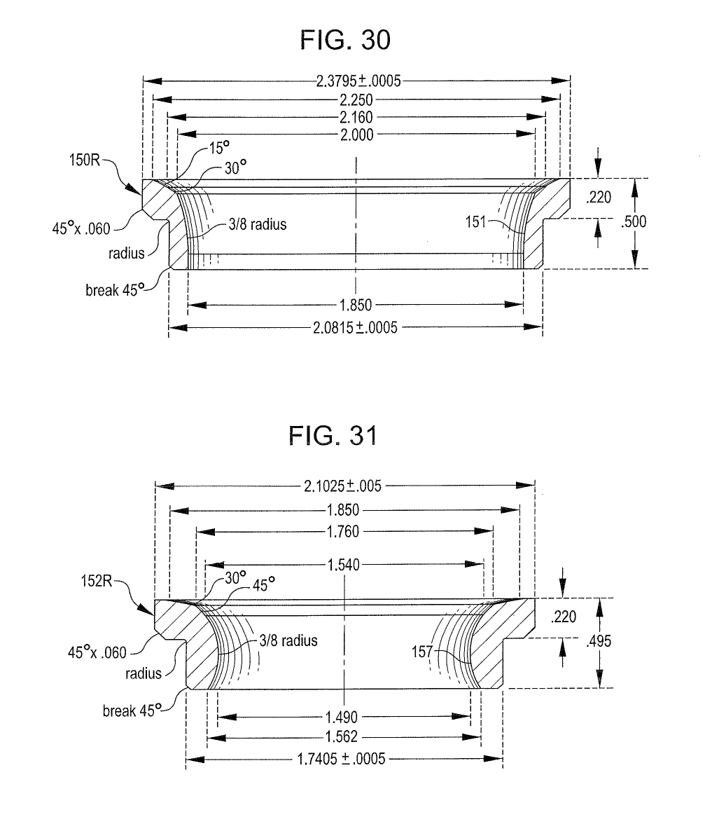

In another embodiment, as shown in FIG. 30, in order to further increase the performance of an engine utilizing the details taught herein, additional refinements may be made to the configuration of intake valve seat inserts 150R. Here, intake valve seat insert 150R is provided with a radiused inlet valve inlet throat 151 that is at least in part, smoothly radiused. In FIG. 30, the use of a radius of three eighths of an inch (⅜″) is illustrated. The relationships of other portions of the inlet valve seat insert 150R are shown in detail, and generally are shaped and sized to provide a smoothly dimensioned inlet valve seat to minimize losses, and thus enhance engine performance.

Also, the exhaust valve seat 152 may comprise an insert having exhaust valve seat sidewalls 156. In an embodiment, the exhaust valve seat inserts 152 have exhaust valve seat sidewalls 156, which are configured for passage there through of exhaust gases. In an embodiment, the exhaust valve seat sidewalls 156 may be provided in cross-sectional shape as seen in FIG. 25, as an aerodynamically shaped surface having a plurality of exhaust valve seat facets respectively oriented at angles as defined at a respective cross-section location of each of the plurality of exhaust valve seat facets. For example, as shown in FIG. 26, the exhaust valve seat sidewalls 156 may comprise, a shaped surface having a plurality of facets Σ₁, Σ₂, Σ₃, Σ₄, Σ₅, Σ₆, or Σ₇, respectively defined in an exhaust gas flow direction indicated by reference arrow EG of sequentially increasing angles, for example, Σ₁, Σ₂, Σ₃, Σ₄, Σ₅, Σ₆, or Σ₇, at the various locations as set forth in FIG. 26. In an embodiment, angle Σ₁ may be at about fifteen degrees (15°). In an embodiment, angle Σ₂ may be at about thirty degrees. In an embodiment, angle Σ₃ may be at about forty-five degrees (45°). In an embodiment, angle Σ₄ may be at about sixty degrees (60°). In an embodiment, angle Σ₅ may be at about seventy-five degrees (75°). In an embodiment, angle Σ₆ may be at about ninety degrees (90°). In an embodiment, angle Σ₇ may be at about one hundred five degrees (105°).

For general description purposes, each facet (E₁, E₂, E₃, E₄, E₅, E₆, E₇, etc.) of an exhaust valve seat insert may have an “in-plane” width described as its facet width F_{W}. In an embodiment the facet E₃ associated with the angle Σ₃ may have a facet width F_{W} of about zero point one five inches (0.150″).

In an embodiment, as seen in FIG. 24, the angle Σ₄ may be at about sixty degrees (60°), and the angle Σ₅ may be at about seventy-five degrees (75°). In an embodiment, the facets E₄ and E₅ associated with angles Σ₄ and Σ5 respectively, may be of approximately equal facet width F_{W}.

In an embodiment, the exhaust valve seat sidewalls 156 may be configured, in cross-sectional shape, as a curve-fitted shaped surface corresponding approximately to the facets E₁, E₂, E₃, E₄, E₅, E₆, or E₇, respectively defined by one or more of the angles Σ₁, Σ₂, Σ₃, Σ₄, Σ₅, Σ₆, or Σ₇, all as noted above, at the respective cross-section locations as set forth in FIG. 26. In an embodiment, the intake valve seat sidewalls 154 may be configured, in cross-sectional shape, as a curve-fitted shaped surface corresponding to shapes defined by each of the angles Σ₁, Σ₂, Σ₃, Σ₄, Σ₅, Σ₆, or Σ₇, at each of the respective cross-section locations as set forth in FIG. 26. In an embodiment, the intake valve seat sidewalls 154 may be configured, in cross-section shape, as a smooth curve fitted surface corresponding approximately to the facet surfaces defined by the series of angles Σ₁, Σ₂, Σ₃, Σ₄, Σ₅, Σ₆, or Σ₇, at the respective cross-section locations as set forth in FIG. 26.

In another embodiment, as shown in FIG. 31, in order to further increase the performance of an engine utilizing the details taught herein, additional refinements may be made to the configuration of exhaust valve seat inserts 152R. Here, exhaust valve seat insert 152R is provided with a radiused inlet valve inlet throat 157 that is at least in part, smoothly radiused. In FIG. 31, the use of a radius of three eighths of an inch (⅜″) is illustrated. The relationships of other portions of the exhaust valve seat insert 152R are shown in detail, and generally are shaped and sized to provide a smoothly dimensioned inlet valve seat to minimize losses, and thus enhance engine performance.

As briefly noted above, the intake valve seat inserts 150 and the exhaust valve seat inserts 152 may be each provided in a parallel valve configuration engine. OR, the intake valve seat inserts 150 and exhaust valve seat inserts 152, as just described above, may be provided for use in an angled valve configuration engine.

It is to be appreciated that the various aspects, features, structures, and embodiments of a cylinder head, intake valve seats, and exhaust valve seats for internal combustion, spark ignition aircraft engines as described herein is a significant improvement in the state of the art. The components described are simple, reliable, and easy to use in lieu of existing cylinder head designs and components, whether on new engines, or as may be retrofitted on existing engines. Although only a few exemplary aspects and embodiments have been described in detail, various details are sufficiently set forth in the drawing figures and in the specification provided herein to enable one of ordinary skill in the art to make and use the invention(s), which need not be further described by additional writing.

Importantly, the aspects, features, structures, and embodiments described and claimed herein may be modified from those shown without materially departing from the novel teachings and advantages provided, and may be embodied in other specific forms without departing from the spirit or essential characteristics thereof. Therefore, the various aspects and embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings. The scope of the invention, as described herein is thus intended to include variations from the various aspects and embodiments provided which are nevertheless described by the broad meaning and range properly afforded to the language herein, as explained by and in light of the terms included herein, or the legal equivalents thereof.

TABLE 3
Intake Port

| (in inches) | X | Y | Z |
|---|---|---|---|
| Section 1 | 0.574 | 0.105 | 0.000 |
| | 0.581 | −0.144 | 0.000 |
| | 0.566 | −0.394 | 0.000 |
| | 0.530 | −0.638 | 0.000 |
| | 0.356 | −0.815 | 0.000 |
| | 0.128 | −0.912 | 0.000 |
| | −0.121 | −0.923 | 0.000 |
| | −0.362 | −0.861 | 0.000 |
| | −0.579 | −0.739 | 0.000 |
| | −0.740 | −0.548 | 0.000 |
| | −0.861 | −0.331 | 0.000 |
| | −0.910 | −0.087 | 0.000 |
| | −0.887 | 0.161 | 0.000 |
| | −0.810 | 0.399 | 0.000 |
| | −0.667 | 0.599 | 0.000 |
| | −0.467 | 0.749 | 0.000 |
| | −0.238 | 0.847 | 0.000 |
| | 0.008 | 0.889 | 0.000 |
| | 0.257 | 0.875 | 0.000 |
| | 0.465 | 0.744 | 0.000 |
| | 0.543 | 0.604 | 0.000 |
| | 0.563 | 0.355 | 0.000 |
| Section 2 | 0.563 | 0.129 | −0.250 |
| | 0.569 | −0.120 | −0.250 |
| | 0.553 | −0.370 | −0.250 |
| | 0.533 | −0.618 | −0.250 |
| | 0.378 | −0.809 | −0.250 |
| | 0.155 | −0.919 | −0.250 |
| | −0.093 | −0.943 | −0.250 |
| | −0.336 | −0.890 | −0.250 |
| | −0.560 | −0.779 | −0.250 |
| | −0.723 | −0.592 | −0.250 |
| | −0.852 | −0.378 | −0.250 |
| | −0.914 | −0.137 | −0.250 |
| | −0.902 | 0.112 | −0.250 |
| | −0.830 | 0.351 | −0.250 |
| | −0.696 | 0.560 | −0.250 |
| | −0.507 | 0.723 | −0.250 |
| | −0.282 | 0.829 | −0.250 |
| | −0.037 | 0.874 | −0.250 |
| | 0.140 | 0.878 | −0.250 |
| | 0.380 | 0.817 | −0.250 |
| | 0.535 | 0.627 | −0.250 |
| | 0.558 | 0.379 | −0.250 |

TABLE 4
Exhaust Port

| (in inches) | X | Y | Z |
|---|---|---|---|
| SECTION 1 | 0.493 | −0.291 | 0.000 |
| | 0.476 | −0.538 | 0.000 |
| | 0.345 | −0.748 | 0.000 |
| | 0.189 | −0.835 | 0.000 |
| | −0.058 | −0.860 | 0.000 |
| | −0.300 | −0.806 | 0.000 |
| | −0.510 | −0.671 | 0.000 |
| | −0.681 | −0.490 | 0.000 |
| | −0.811 | −0.278 | 0.000 |
| | −0.871 | −0.036 | 0.000 |
| | −0.859 | 0.211 | 0.000 |
| | −0.774 | 0.446 | 0.000 |
| | −0.635 | 0.652 | 0.000 |
| | −0.436 | 0.801 | 0.000 |
| | −0.196 | 0.865 | 0.000 |
| | 0.037 | 0.832 | 0.000 |
| | 0.214 | 0.665 | 0.000 |
| | 0.318 | 0.437 | 0.000 |
| | 0.386 | 0.197 | 0.000 |
| | 0.448 | −0.045 | 0.000 |
| SECTION 2 | 0.471 | −0.373 | −0.250 |
| | 0.428 | −0.617 | −0.250 |
| | 0.270 | −0.804 | −0.250 |
| | 0.029 | −0.860 | −0.250 |
| | −0.219 | −0.835 | −0.250 |
| | −0.445 | −0.731 | −0.250 |
| | −0.631 | −0.565 | −0.250 |
| | −0.716 | −0.461 | −0.250 |
| | −0.833 | −0.240 | −0.250 |
| | −0.884 | 0.004 | −0.250 |
| | −0.858 | 0.251 | −0.250 |
| | −0.765 | 0.482 | −0.250 |
| | −0.618 | 0.684 | −0.250 |
| | −0.413 | 0.824 | −0.250 |
| | −0.170 | 0.864 | −0.250 |
| | 0.065 | 0.789 | −0.250 |
| | 0.211 | 0.590 | −0.250 |
| | 0.300 | 0.356 | −0.250 |
| | 0.369 | 0.116 | −0.250 |
| | 0.426 | −0.127 | −0.250 |
| SECTION 3 | 0.440 | −0.406 | −0.500 |
| | 0.432 | −0.654 | −0.500 |
| | 0.288 | −0.849 | −0.500 |
| | 0.043 | −0.881 | −0.500 |
| | −0.203 | −0.838 | −0.500 |
| | −0.427 | −0.729 | −0.500 |
| | −0.615 | −0.565 | −0.500 |
| | −0.702 | −0.456 | −0.500 |
| | −0.821 | −0.237 | −0.500 |
| | −0.876 | 0.006 | −0.500 |
| | −0.856 | 0.254 | −0.500 |
| | −0.764 | 0.485 | −0.500 |
| | −0.621 | 0.690 | −0.500 |
| | −0.420 | 0.836 | −0.500 |
| | −0.178 | 0.872 | −0.500 |
| | 0.046 | 0.765 | −0.500 |
| | 0.180 | 0.557 | −0.500 |
| | 0.264 | 0.322 | −0.500 |
| | 0.340 | 0.083 | −0.500 |
| | 0.400 | −0.159 | −0.500 |

TABLE 3
Intake Port

| | X | Y | Z |
|---|---|---|---|
| Section 1 | 0.574 | 0.105 | 0.000 |
| | 0.581 | −0.144 | 0.000 |
| | 0.566 | −0.394 | 0.000 |
| | 0.530 | −0.638 | 0.000 |
| | 0.356 | −0.815 | 0.000 |
| | 0.128 | −0.912 | 0.000 |
| | −0.121 | −0.923 | 0.000 |
| | −0.362 | −0.861 | 0.000 |
| | −0.579 | −0.739 | 0.000 |
| | −0.740 | −0.548 | 0.000 |
| | −0.861 | −0.331 | 0.000 |
| | −0.910 | −0.087 | 0.000 |
| | −0.887 | 0.161 | 0.000 |
| | −0.810 | 0.399 | 0.000 |
| | −0.667 | 0.599 | 0.000 |
| | −0.467 | 0.749 | 0.000 |
| | −0.238 | 0.847 | 0.000 |
| | 0.008 | 0.889 | 0.000 |
| | 0.257 | 0.875 | 0.000 |
| | 0.465 | 0.744 | 0.000 |
| | 0.543 | 0.604 | 0.000 |
| | 0.563 | 0.355 | 0.000 |
| Section 2 | 0.563 | 0.129 | −0.250 |
| | 0.569 | −0.120 | −0.250 |
| | 0.553 | −0.370 | −0.250 |
| | 0.533 | −0.618 | −0.250 |
| | 0.378 | −0.809 | −0.250 |
| | 0.155 | −0.919 | −0.250 |
| | −0.093 | −0.943 | −0.250 |
| | −0.336 | −0.890 | −0.250 |
| | −0.560 | −0.779 | −0.250 |
| | −0.723 | −0.592 | −0.250 |
| | −0.852 | −0.378 | −0.250 |
| | −0.914 | −0.137 | −0.250 |
| | −0.902 | 0.112 | −0.250 |
| | −0.830 | 0.351 | −0.250 |
| | −0.696 | 0.560 | −0.250 |
| | −0.507 | 0.723 | −0.250 |
| | −0.282 | 0.829 | −0.250 |
| | −0.037 | 0.874 | −0.250 |
| | 0.140 | 0.878 | −0.250 |
| | 0.380 | 0.817 | −0.250 |
| | 0.535 | 0.627 | −0.250 |
| | 0.558 | 0.379 | −0.250 |
| Section 3 | 0.549 | 0.043 | −0.500 |
| | 0.549 | −0.207 | −0.500 |
| | 0.545 | −0.457 | −0.500 |
| | 0.485 | −0.696 | −0.500 |
| | 0.327 | −0.859 | −0.500 |
| | 0.097 | −0.952 | −0.500 |
| | −0.152 | −0.957 | −0.500 |
| | −0.392 | −0.889 | −0.500 |
| | −0.607 | −0.766 | −0.500 |
| | −0.766 | −0.573 | −0.500 |
| | −0.883 | −0.353 | −0.500 |
| | −0.925 | −0.107 | −0.500 |
| | −0.901 | 0.140 | −0.500 |
| | −0.822 | 0.377 | −0.500 |
| | −0.682 | 0.583 | −0.500 |
| | −0.490 | 0.741 | −0.500 |
| | −0.262 | 0.842 | −0.500 |
| | −0.016 | 0.888 | −0.500 |
| | 0.232 | 0.887 | −0.500 |
| | 0.449 | 0.769 | −0.500 |
| | 0.543 | 0.543 | −0.500 |
| | 0.549 | 0.293 | −0.500 |
| Section 4 | 0.559 | 0.015 | −0.750 |
| | 0.549 | −0.235 | −0.750 |
| | 0.543 | −0.485 | −0.750 |
| | 0.465 | −0.720 | −0.750 |
| | 0.306 | −0.910 | −0.750 |
| | 0.177 | −0.971 | −0.750 |
| | −0.070 | −1.004 | −0.750 |
| | −0.316 | −0.962 | −0.750 |
| | −0.544 | −0.862 | −0.750 |
| | −0.728 | −0.694 | −0.750 |
| | −0.858 | −0.481 | −0.750 |
| | −0.927 | −0.242 | −0.750 |
| | −0.931 | 0.008 | −0.750 |
| | −0.876 | 0.251 | −0.750 |
| | −0.771 | 0.477 | −0.750 |
| | −0.601 | 0.660 | −0.750 |
| | −0.394 | 0.798 | −0.750 |
| | −0.163 | 0.891 | −0.750 |
| | 0.082 | 0.944 | −0.750 |
| | 0.328 | 0.925 | −0.750 |
| | 0.505 | 0.757 | −0.750 |
| | 0.561 | 0.515 | −0.750 |
| | 0.566 | 0.265 | −0.750 |
| Section 5 | 0.632 | 0.128 | −1.000 |
| | 0.591 | −0.119 | −1.000 |
| | 0.556 | −0.366 | −1.000 |
| | 0.518 | −0.612 | −1.000 |
| | 0.405 | −0.834 | −1.000 |
| | 0.214 | −0.989 | −1.000 |
| | −0.031 | −1.034 | −1.000 |
| | −0.278 | −1.004 | −1.000 |
| | −0.514 | −0.920 | −1.000 |
| | −0.640 | −0.826 | −1.000 |
| | −0.803 | −0.636 | −1.000 |
| | −0.900 | −0.407 | −1.000 |
| | −0.939 | −0.161 | −1.000 |
| | −0.914 | 0.087 | −1.000 |
| | −0.825 | 0.320 | −1.000 |
| | −0.698 | 0.535 | −1.000 |
| | −0.519 | 0.709 | −1.000 |
| | −0.311 | 0.847 | −1.000 |
| | −0.085 | 0.951 | −1.000 |
| | 0.156 | 1.019 | −1.000 |
| | 0.403 | 1.022 | −1.000 |
| | 0.590 | 0.868 | −1.000 |
| | 0.641 | 0.627 | −1.000 |
| | 0.652 | 0.377 | −1.000 |
| Section 6 | 0.777 | 0.131 | −1.250 |
| | 0.678 | −0.099 | −1.250 |
| | 0.606 | −0.338 | −1.250 |
| | 0.543 | −0.580 | −1.250 |
| | 0.446 | −0.807 | −1.250 |
| | 0.266 | −0.978 | −1.250 |
| | 0.028 | −1.049 | −1.250 |
| | −0.221 | −1.039 | −1.250 |
| | −0.492 | −0.954 | −1.250 |
| | −0.695 | −0.808 | −1.250 |
| | −0.849 | −0.614 | −1.250 |
| | −0.913 | −0.374 | −1.250 |
| | −0.904 | −0.125 | −1.250 |
| | −0.783 | 0.091 | −1.250 |
| | −0.636 | 0.292 | −1.250 |
| | −0.543 | 0.524 | −1.250 |
| | −0.410 | 0.733 | −1.250 |
| | −0.217 | 0.893 | −1.250 |
| | −0.004 | 1.022 | −1.250 |
| | 0.228 | 1.116 | −1.250 |
| | 0.472 | 1.161 | −1.250 |
| | 0.697 | 1.072 | −1.250 |
| | 0.833 | 0.875 | −1.250 |
| | 0.828 | 0.625 | −1.250 |
| | 0.826 | 0.375 | −1.250 |
| Section 7 | 1.269 | 0.214 | −1.500 |
| | 1.022 | 0.200 | −1.500 |
| | 0.856 | 0.015 | −1.500 |
| | 0.756 | −0.213 | −1.500 |
| | 0.662 | −0.444 | −1.500 |
| | 0.555 | −0.666 | −1.500 |
| | 0.207 | −1.004 | −1.500 |
| | 0.417 | −0.872 | −1.500 |
| | −0.038 | −1.046 | −1.500 |
| | −0.287 | −1.020 | −1.500 |
| | −0.521 | −0.935 | −1.500 |
| | −0.712 | −0.775 | −1.500 |
| | −0.848 | −0.568 | −1.500 |
| | −0.873 | −0.322 | −1.500 |
| | −0.732 | −0.123 | −1.500 |
| | −0.541 | 0.038 | −1.500 |
| | −0.376 | 0.225 | −1.500 |
| | −0.269 | 0.450 | −1.500 |
| | −0.206 | 0.692 | −1.500 |
| | −0.093 | 0.914 | −1.500 |
| | 0.084 | 1.089 | −1.500 |
| | 0.298 | 1.218 | −1.500 |
| | 0.541 | 1.272 | −1.500 |
| | 0.790 | 1.261 | −1.500 |
| | 0.969 | 1.091 | −1.500 |
| | 1.168 | 0.943 | −1.500 |
| | 1.338 | 0.914 | −1.500 |
| Section 8 | 1.258 | −0.097 | −1.750 |
| | 1.048 | −0.203 | −1.750 |
| | 0.855 | −0.361 | −1.750 |
| | 0.668 | −0.524 | −1.750 |
| | 0.544 | −0.741 | −1.750 |
| | 0.364 | −0.912 | −1.750 |
| | 0.135 | −1.007 | −1.750 |
| | −0.114 | −1.017 | −1.750 |
| | −0.360 | −0.975 | −1.750 |
| | −0.575 | −0.849 | −1.750 |
| | −0.748 | −0.670 | −1.750 |
| | −0.834 | −0.440 | −1.750 |
| | −0.731 | −0.222 | −1.750 |
| | −0.523 | −0.084 | −1.750 |
| | −0.319 | 0.061 | −1.750 |
| | −0.115 | 0.204 | −1.750 |
| | −0.001 | 0.418 | −1.750 |
| | 0.027 | 0.665 | −1.750 |
| | 0.060 | 0.909 | −1.750 |
| | 0.175 | 1.131 | −1.750 |
| | 0.376 | 1.265 | −1.750 |
| | 0.625 | 1.285 | −1.750 |
| | 0.873 | 1.256 | −1.750 |
| | 1.121 | 1.225 | −1.750 |
| | 1.360 | 1.225 | −1.750 |
| Section 9 | 1.287 | −0.227 | −2.000 |
| | 1.044 | −0.253 | −2.000 |
| | 0.838 | −0.395 | −2.000 |
| | 0.663 | −0.572 | −2.000 |
| | 0.518 | −0.775 | −2.000 |
| | 0.311 | −0.912 | −2.000 |
| | 0.069 | −0.967 | −2.000 |
| | −0.179 | −0.948 | −2.000 |
| | −0.416 | −0.870 | −2.000 |
| | −0.622 | −0.732 | −2.000 |
| | −0.747 | −0.518 | −2.000 |
| | −0.721 | −0.277 | −2.000 |
| | −0.540 | −0.107 | −2.000 |
| | −0.330 | 0.029 | −2.000 |
| | −0.108 | 0.143 | −2.000 |
| | 0.110 | 0.265 | −2.000 |
| | 0.207 | 0.486 | −2.000 |
| | 0.192 | 0.736 | −2.000 |
| | 0.198 | 0.985 | −2.000 |
| | 0.293 | 1.213 | −2.000 |
| | 0.521 | 1.300 | −2.000 |
| | 0.769 | 1.326 | −2.000 |
| | 1.078 | 1.355 | −2.000 |
| | 1.368 | 1.356 | −2.000 |
| Section 10 | 1.310 | −0.267 | −2.250 |
| | 1.056 | −0.276 | −2.250 |
| | 0.839 | −0.398 | −2.250 |
| | 0.671 | −0.581 | −2.250 |
| | 0.500 | −0.762 | −2.250 |
| | 0.278 | −0.873 | −2.250 |
| | 0.030 | −0.895 | −2.250 |
| | −0.216 | −0.853 | −2.250 |
| | −0.446 | −0.757 | −2.250 |
| | −0.628 | −0.589 | −2.250 |
| | −0.688 | −0.348 | −2.250 |
| | −0.571 | −0.135 | −2.250 |
| | −0.367 | 0.009 | −2.250 |
| | −0.164 | 0.154 | −2.250 |
| | 0.021 | 0.322 | −2.250 |
| | 0.155 | 0.531 | −2.250 |
| | 0.208 | 0.775 | −2.250 |
| | 0.256 | 1.020 | −2.250 |
| | 0.396 | 1.218 | −2.250 |
| | 0.627 | 1.312 | −2.250 |
| | 0.870 | 1.370 | −2.250 |
| | 1.119 | 1.391 | −2.250 |
| | 1.369 | 1.396 | −2.250 |
| Section 11 | 1.310 | −0.230 | −2.500 |
| | 0.974 | −0.282 | −2.500 |
| | 0.776 | −0.432 | −2.500 |
| | 0.613 | −0.622 | −2.500 |
| | 0.401 | −0.751 | −2.500 |
| | 0.155 | −0.791 | −2.500 |
| | −0.095 | −0.777 | −2.500 |
| | −0.324 | −0.682 | −2.500 |
| | −0.523 | −0.533 | −2.500 |
| | −0.598 | −0.298 | −2.500 |
| | −0.479 | −0.087 | −2.500 |
| | −0.289 | 0.075 | −2.500 |
| | −0.115 | 0.255 | −2.500 |
| | 0.034 | 0.455 | −2.500 |
| | 0.154 | 0.674 | −2.500 |
| | 0.256 | 0.902 | −2.500 |
| | 0.417 | 1.089 | −2.500 |
| | 0.642 | 1.198 | −2.500 |
| | 0.878 | 1.278 | −2.500 |
| | 1.121 | 1.337 | −2.500 |
| | 1.370 | 1.358 | −2.500 |
| Section 12 | 1.313 | −0.103 | −2.750 |
| | 0.961 | −0.192 | −2.750 |
| | 0.767 | −0.349 | −2.750 |
| | 0.584 | −0.520 | −2.750 |
| | 0.363 | −0.632 | −2.750 |
| | 0.114 | −0.648 | −2.750 |
| | −0.126 | −0.584 | −2.750 |
| | −0.354 | −0.485 | −2.750 |
| | −0.459 | −0.270 | −2.750 |
| | −0.370 | −0.039 | −2.750 |
| | −0.205 | 0.148 | −2.750 |
| | −0.052 | 0.346 | −2.750 |
| | 0.090 | 0.551 | −2.750 |
| | 0.243 | 0.749 | −2.750 |
| | 0.436 | 0.906 | −2.750 |
| | 0.653 | 1.030 | −2.750 |
| | 0.881 | 1.133 | −2.750 |
| | 1.120 | 1.205 | −2.750 |
| | 1.368 | 1.232 | −2.750 |
| Section 13 | 1.281 | 0.197 | −3.000 |
| | 1.076 | 0.156 | −3.000 |
| | 0.878 | −0.035 | −3.000 |
| | 0.676 | −0.182 | −3.000 |
| | 0.469 | −0.317 | −3.000 |
| | 0.224 | −0.364 | −3.000 |
| | −0.018 | −0.310 | −3.000 |
| | −0.188 | −0.140 | −3.000 |
| | −0.092 | 0.089 | −3.000 |
| | 0.046 | 0.296 | −3.000 |
| | 0.212 | 0.483 | −3.000 |
| | 0.410 | 0.635 | −3.000 |
| | 0.634 | 0.745 | −3.000 |
| | 0.866 | 0.838 | −3.000 |
| | 1.105 | 0.913 | −3.000 |
| | 1.353 | 0.932 | −3.000 |

TABLE 4
Exhaust Port

| (in inches) | X | Y | Z |
|---|---|---|---|
| SECTION 1 | 0.493 | −0.291 | 0.000 |
| | 0.476 | −0.538 | 0.000 |
| | 0.345 | −0.748 | 0.000 |
| | 0.189 | −0.835 | 0.000 |
| | −0.058 | −0.860 | 0.000 |
| | −0.300 | −0.806 | 0.000 |
| | −0.510 | −0.671 | 0.000 |
| | −0.681 | −0.490 | 0.000 |
| | −0.811 | −0.278 | 0.000 |
| | −0.871 | −0.036 | 0.000 |
| | −0.859 | 0.211 | 0.000 |
| | −0.774 | 0.446 | 0.000 |
| | −0.635 | 0.652 | 0.000 |
| | −0.436 | 0.801 | 0.000 |
| | −0.196 | 0.865 | 0.000 |
| | 0.037 | 0.832 | 0.000 |
| | 0.214 | 0.665 | 0.000 |
| | 0.318 | 0.437 | 0.000 |
| | 0.386 | 0.197 | 0.000 |
| | 0.448 | −0.045 | 0.000 |
| SECTION 2 | 0.471 | −0.373 | −0.250 |
| | 0.428 | −0.617 | −0.250 |
| | 0.270 | −0.804 | −0.250 |
| | 0.029 | −0.860 | −0.250 |
| | −0.219 | −0.835 | −0.250 |
| | −0.445 | −0.731 | −0.250 |
| | −0.631 | −0.565 | −0.250 |
| | −0.716 | −0.461 | −0.250 |
| | −0.833 | −0.240 | −0.250 |
| | −0.884 | 0.004 | −0.250 |
| | −0.858 | 0.251 | −0.250 |
| | −0.765 | 0.482 | −0.250 |
| | −0.618 | 0.684 | −0.250 |
| | −0.413 | 0.824 | −0.250 |
| | −0.170 | 0.864 | −0.250 |
| | 0.065 | 0.789 | −0.250 |
| | 0.211 | 0.590 | −0.250 |
| | 0.300 | 0.356 | −0.250 |
| | 0.369 | 0.116 | −0.250 |
| | 0.426 | −0.127 | −0.250 |
| SECTION 3 | 0.440 | −0.406 | −0.500 |
| | 0.432 | −0.654 | −0.500 |
| | 0.288 | −0.849 | −0.500 |
| | 0.043 | −0.881 | −0.500 |
| | −0.203 | −0.838 | −0.500 |
| | −0.427 | −0.729 | −0.500 |
| | −0.615 | −0.565 | −0.500 |
| | −0.702 | −0.456 | −0.500 |
| | −0.821 | −0.237 | −0.500 |
| | −0.876 | 0.006 | −0.500 |
| | −0.856 | 0.254 | −0.500 |
| | −0.764 | 0.485 | −0.500 |
| | −0.621 | 0.690 | −0.500 |
| | −0.420 | 0.836 | −0.500 |
| | −0.178 | 0.872 | −0.500 |
| | 0.046 | 0.765 | −0.500 |
| | 0.180 | 0.557 | −0.500 |
| | 0.264 | 0.322 | −0.500 |
| | 0.340 | 0.083 | −0.500 |
| | 0.400 | −0.159 | −0.500 |
| SECTION 4 | 0.495 | −0.541 | −0.750 |
| | 0.453 | −0.785 | −0.750 |
| | 0.259 | −0.927 | −0.750 |
| | 0.011 | −0.927 | −0.750 |
| | −0.193 | −0.848 | −0.750 |
| | −0.408 | −0.722 | −0.750 |
| | −0.583 | −0.545 | −0.750 |
| | −0.717 | −0.333 | −0.750 |
| | −0.823 | −0.109 | −0.750 |
| | −0.854 | 0.138 | −0.750 |
| | −0.793 | 0.380 | −0.750 |
| | −0.671 | 0.598 | −0.750 |
| | −0.497 | 0.775 | −0.750 |
| | −0.271 | 0.877 | −0.750 |
| | −0.034 | 0.817 | −0.750 |
| | 0.149 | 0.651 | −0.750 |
| | 0.248 | 0.423 | −0.750 |
| | 0.338 | 0.189 | −0.750 |
| | 0.414 | −0.049 | −0.750 |
| | 0.468 | −0.293 | −0.750 |
| SECTION 5 | 0.619 | −0.476 | −1.000 |
| | 0.633 | −0.724 | −1.000 |
| | 0.504 | −0.931 | −1.000 |
| | 0.268 | −0.997 | −1.000 |
| | 0.026 | −0.946 | −1.000 |
| | −0.197 | −0.834 | −1.000 |
| | −0.375 | −0.663 | −1.000 |
| | −0.484 | −0.438 | −1.000 |
| | −0.647 | −0.250 | −1.000 |
| | −0.771 | −0.036 | −1.000 |
| | −0.796 | 0.083 | −1.000 |
| | −0.766 | 0.330 | −1.000 |
| | −0.661 | 0.555 | −1.000 |
| | −0.495 | 0.742 | −1.000 |
| | −0.276 | 0.858 | −1.000 |
| | −0.035 | 0.830 | −1.000 |
| | 0.163 | 0.680 | −1.000 |
| | 0.283 | 0.461 | −1.000 |
| | 0.387 | 0.234 | −1.000 |
| | 0.484 | 0.004 | −1.000 |
| | 0.570 | −0.231 | −1.000 |
| SECTION 6 | 0.865 | −0.540 | −1.250 |
| | 0.833 | −0.785 | −1.250 |
| | 0.679 | −0.979 | −1.250 |
| | 0.449 | −1.069 | −1.250 |
| | 0.204 | −1.032 | −1.250 |
| | −0.018 | −0.918 | −1.250 |
| | −0.182 | −0.732 | −1.250 |
| | −0.261 | −0.495 | −1.250 |
| | −0.395 | −0.285 | −1.250 |
| | −0.585 | −0.126 | −1.250 |
| | −0.657 | −0.037 | −1.250 |
| | −0.721 | 0.201 | −1.250 |
| | −0.658 | 0.442 | −1.250 |
| | −0.521 | 0.650 | −1.250 |
| | −0.329 | 0.806 | −1.250 |
| | −0.087 | 0.855 | −1.250 |
| | 0.137 | 0.750 | −1.250 |
| | 0.300 | 0.563 | −1.250 |
| | 0.420 | 0.344 | −1.250 |
| | 0.543 | 0.127 | −1.250 |
| | 0.685 | −0.078 | −1.250 |
| | 0.762 | −0.314 | −1.250 |
| SECTION 7 | 1.290 | −0.828 | −1.500 |
| | 1.057 | −0.912 | −1.500 |
| | 0.857 | −1.063 | −1.500 |
| | 0.631 | −1.164 | −1.500 |
| | 0.389 | −1.128 | −1.500 |
| | 0.167 | −1.014 | −1.500 |
| | 0.018 | −0.817 | −1.500 |
| | −0.025 | −0.571 | −1.500 |
| | −0.116 | −0.340 | −1.500 |
| | −0.285 | −0.157 | −1.500 |
| | −0.492 | −0.017 | −1.500 |
| | −0.612 | 0.197 | −1.500 |
| | −0.556 | 0.436 | −1.500 |
| | −0.426 | 0.649 | −1.500 |
| | −0.228 | 0.798 | −1.500 |
| | 0.017 | 0.829 | −1.500 |
| | 0.239 | 0.720 | −1.500 |
| | 0.402 | 0.532 | −1.500 |
| | 0.537 | 0.322 | −1.500 |
| | 0.686 | 0.123 | −1.500 |
| | 0.875 | −0.039 | −1.500 |
| | 1.094 | −0.160 | −1.500 |
| | 1.247 | −0.351 | −1.500 |
| SECTION 8 | 1.316 | −1.194 | −1.750 |
| | 0.977 | −1.202 | −1.750 |
| | 0.739 | −1.277 | −1.750 |
| | 0.502 | −1.276 | −1.750 |
| | 0.329 | −1.097 | −1.750 |
| | 0.199 | −0.891 | −1.750 |
| | 0.207 | −0.642 | −1.750 |
| | 0.163 | −0.399 | −1.750 |
| | 0.019 | −0.197 | −1.750 |
| | −0.183 | −0.050 | −1.750 |
| | −0.395 | 0.080 | −1.750 |
| | −0.464 | 0.311 | −1.750 |
| | −0.371 | 0.542 | −1.750 |
| | −0.211 | 0.729 | −1.750 |
| | 0.024 | 0.807 | −1.750 |
| | 0.262 | 0.743 | −1.750 |
| | 0.451 | 0.583 | −1.750 |
| | 0.611 | 0.393 | −1.750 |
| | 0.768 | 0.201 | −1.750 |
| | 0.979 | 0.069 | −1.750 |
| | 1.218 | 0.015 | −1.750 |
| SECTION 9 | 1.324 | −1.330 | −2.000 |
| | 0.959 | −1.410 | −2.000 |
| | 0.720 | −1.412 | −2.000 |
| | 0.504 | −1.380 | −2.000 |
| | 0.383 | −1.162 | −2.000 |
| | 0.329 | −0.919 | −2.000 |
| | 0.351 | −0.671 | −2.000 |
| | 0.303 | −0.426 | −2.000 |
| | 0.192 | −0.206 | −2.000 |
| | −0.006 | −0.054 | −2.000 |
| | −0.208 | 0.092 | −2.000 |
| | −0.316 | 0.308 | −2.000 |
| | −0.233 | 0.540 | −2.000 |
| | −0.053 | 0.710 | −2.000 |
| | 0.189 | 0.759 | −2.000 |
| | 0.421 | 0.678 | −2.000 |
| | 0.614 | 0.518 | −2.000 |
| | 0.762 | 0.320 | −2.000 |
| | 0.979 | 0.199 | −2.000 |
| | 1.220 | 0.152 | −2.000 |
| SECTION 10 | 1.327 | −1.369 | −2.250 |
| | 1.077 | −1.371 | −2.250 |
| | 0.832 | −1.420 | −2.250 |
| | 0.601 | −1.411 | −2.250 |
| | 0.423 | −1.284 | −2.250 |
| | 0.353 | −1.045 | −2.250 |
| | 0.327 | −0.797 | −2.250 |
| | 0.343 | −0.548 | −2.250 |
| | 0.322 | −0.300 | −2.250 |
| | 0.134 | −0.153 | −2.250 |
| | −0.029 | 0.035 | −2.250 |
| | −0.135 | 0.259 | −2.250 |
| | −0.089 | 0.497 | −2.250 |
| | 0.101 | 0.655 | −2.250 |
| | 0.345 | 0.688 | −2.250 |
| | 0.572 | 0.590 | −2.250 |
| | 0.763 | 0.430 | −2.250 |
| | 0.949 | 0.275 | −2.250 |
| | 1.220 | 0.190 | −2.250 |
| SECTION 11 | 1.325 | −1.325 | −2.500 |
| | 1.075 | −1.325 | −2.500 |
| | 0.825 | −1.325 | −2.500 |
| | 0.589 | −1.341 | −2.500 |
| | 0.368 | −1.248 | −2.500 |
| | 0.282 | −1.014 | −2.500 |
| | 0.285 | −0.765 | −2.500 |
| | 0.352 | −0.526 | −2.500 |
| | 0.350 | −0.277 | −2.500 |
| | 0.181 | −0.099 | −2.500 |
| | 0.073 | 0.125 | −2.500 |
| | 0.084 | 0.371 | −2.500 |
| | 0.256 | 0.542 | −2.500 |
| | 0.502 | 0.562 | −2.500 |
| | 0.719 | 0.444 | −2.500 |
| | 0.901 | 0.276 | −2.500 |
| | 1.205 | 0.154 | −2.500 |
| SECTION 12 | 1.316 | −1.181 | −2.750 |
| | 1.066 | −1.181 | −2.750 |
| | 0.818 | −1.200 | −2.750 |
| | 0.570 | −1.236 | −2.750 |
| | 0.338 | −1.169 | −2.750 |
| | 0.262 | −0.934 | −2.750 |
| | 0.324 | −0.693 | −2.750 |
| | 0.391 | −0.453 | −2.750 |
| | 0.382 | −0.209 | −2.750 |
| | 0.277 | 0.011 | −2.750 |
| | 0.378 | 0.232 | −2.750 |
| | 0.621 | 0.269 | −2.750 |
| | 0.847 | 0.168 | −2.750 |
| | 1.054 | 0.030 | −2.750 |
| | 1.179 | 0.003 | −2.750 |
| SECTION 13 | 1.278 | −0.774 | −3.000 |
| | 1.028 | −0.774 | −3.000 |
| | 0.818 | −0.891 | −3.000 |
| | 0.590 | −0.822 | −3.000 |
| | 0.548 | −0.586 | −3.000 |
| | 0.610 | −0.347 | −3.000 |
| | 0.819 | −0.246 | −3.000 |
| | 1.061 | −0.302 | −3.000 |
| | 1.221 | −0.404 | −3.000 |

1. A cylinder head for aircraft engines, said cylinder head configured for attachment to a cylinder body having a cylinder bore of diameter defined by a sidewall, and an outer end, the cylinder bore configured to operably confine a piston of selected stroke distance, and with the piston thereby defines a swept displacement volume, said cylinder head comprising:
a head portion, said head portion having therein an inlet passageway defined by inlet passageway sidewalls, said inlet passageway extending between an upstream inlet and an intake valve seat, and defining an inlet passageway volume, and wherein the inlet passageway sidewalls are defined by a profile according to the Cartesian coordinate values of X, Y and Z set forth in Table 3, wherein the X, Y and Z coordinate values are dimensional values representing a distance from an origin point of an internal coordinate system for the inlet passageway, and wherein said intake valve seat comprises an insert having intake valve seat sidewalls.

2. A cylinder head as defined in claim 1, wherein the Cartesian coordinate values of X, Y and Z set forth in Table 3 are scalable as a function of the same constant or number, so as to provide for dimensions of a cylinder head of a selected size having an inlet passageway of a selected inlet passageway volume.

3. The cylinder head as set forth in claim 1, wherein the X, Y and Z coordinate values are dimensional values representing a distance from an origin point of an internal coordinate system for the inlet passageway, and wherein said inlet passageway sidewalls described by said dimensional values in Table 3 are connected by smooth surfaces, so as to provide smooth inlet passageway sidewalls.

4. The cylinder head as set forth in claim 2, wherein said inlet passageway volume is in the range from about thirty percent (30%) to about twenty five percent (25%) of said swept displacement volume.

5. The cylinder head as set forth in claim 4, wherein said inlet passageway volume is about twenty eight percent (28%), or less, of said swept displacement volume.

6. The cylinder head as defined in claim 1, wherein said head portion further comprises an exhaust passageway defined by exhaust passageway sidewalls, said exhaust gas passageway extending between a exhaust valve seat and an exhaust outlet, and defining an exhaust passageway volume, and wherein the exhaust passageway sidewalls are defined by a profile according to the Cartesian coordinate values of X, Y and Z set forth in Table 4, wherein the X, Y and Z coordinate values are dimensional values representing a distance from an origin point of an internal coordinate system for the exhaust passageway, and wherein said exhaust valve seat comprises an insert having exhaust valve seat sidewalls.

7. A cylinder head as defined in claim 6, wherein the Cartesian coordinate values of X, Y and Z set forth in Table 4 are scalable as a function of the same constant or number, so as to provide for dimensions of a cylinder head of a selected size having an exhaust passageway of a selected exhaust passageway volume.

8. The cylinder head as set forth in claim 6, wherein the X, Y and Z coordinate values in Table 4 are dimensional values representing a distance from an origin point of an internal coordinate system for the exhaust passageway, and wherein said exhaust passageway sidewalls described by said dimensional values are connected by smooth surfaces, so as to provide smooth exhaust passageway sidewalls.

9. The cylinder head as set forth in claim 6, wherein at said exhaust outlet, said exhaust passageway has, in cross-section, a stylized-D shape.

10. The cylinder head as set forth in claim 9, wherein said stylized-D shape further comprises a relatively flat portion having rounded corners.

11. The cylinder head as set forth in claim 6, wherein said exhaust passageway has exhaust passageway sidewalls that define, between said exhaust valve seat and said exhaust outlet, an exhaust passageway volume sized such that, when measured at equivalent pressure drop, the gas flow through said exhaust passageway of exhaust passageway volume is about seventy five percent (75%), or less, of the gas flow through said inlet passageway.

12. The cylinder head as set forth in claim 2, wherein at said upstream inlet, said inlet passageway has, in cross-section, a kidney shape comprising a first lobe and a second lobe.

13. The cylinder head as set forth in claim 12, wherein said first lobe and said second lobe are of uneven size.

14. The cylinder head as set forth in claim 1, wherein said intake valve seat sidewalls comprise, in cross-sectional shape, an aerodynamically shaped surface having a plurality of intake valve seat facets respectively oriented at angles in an inlet airflow direction of sequentially decreasing angles.

15. An apparatus as set forth in claim 1, wherein said intake valve seat sidewalls comprise a shaped surface having a plurality of facets in an inlet airflow direction of I₇ I₆, I₅, I₄, I₃, I₂, and I₁, and, defined respectively by angle β₇ of about one hundred five degrees, β₆ of about ninety degrees, β₅ of about seventy five degrees, β₄ of about sixty degrees, β₃ of about forty five degrees, β₂ of about thirty degrees, and β₁ of about fifteen degrees.

16. A cylinder head as set forth in claim 1, wherein said intake valve seat sidewalls comprise a smooth, curve-fitted shaped surface corresponding in curvature to a plurality of facets in an inlet airflow direction of I₇ I₆, I₅, I₄, I₃, I₂, and I₁, and, defined respectively by angle β₇ of about one hundred five degrees, β₆ of about ninety degrees, β₅ of about seventy five degrees, β₄ of about sixty degrees, β₃ of about forty five degrees, β₂ of about thirty degrees, and β₁ of about fifteen degrees.

17. A cylinder head as set forth in claim 16, wherein facet I₂ associated with said angle β₂ has a width F_{W} of about zero point one two inches (0.12″).

18. A cylinder head as set forth in claim 7, wherein facets I₃, I₄, I₅ associated with each of angles β₃, β₄, and β₅ respectively, are of approximately equal facet width F_{W}.

19. A cylinder head as set forth in claim 6, wherein said exhaust valve seat sidewalls comprise an aerodynamically shaped surface having a plurality of exhaust valve seat facets respectively oriented at angles as defined in an exhaust gas flow direction of sequentially increasing angles.

20. A cylinder head as set forth in claim 19, wherein said exhaust valve seat sidewalls comprise, in cross-sectional shape, a shaped surface having a plurality of facets E₁, E₂, E₃, E₄, E₅, E₆, or E₇, defined respectively by angle Σ₁ of about fifteen degrees, Σ₂ of about thirty degrees, Σ₃ of about forty five degrees, Σ₄ of about sixty degrees, Σ₅ of about seventy five degrees, Σ₆ of about ninety degrees, and Σ₇ of about one hundred five degrees.

21. A cylinder head as set forth in claim 20, wherein facet E₃ associated with said angle Σ₃ has a width F_{W} of about zero point one five inches (0.15″).

22. A cylinder head as set forth in claim 20, wherein said angle E₄ is about sixty degrees (60°), and said angle Σ₅ is about seventy five degrees (75°), and wherein facets E₄ and E₅ associated with each of angles Σ₄ and Σ₅ respectively, are of approximately equal facet width F_{W}.

23. A cylinder head as set forth in claim 19, wherein said exhaust valve seat sidewalls comprise, in cross-sectional shape, a curve-fitted shaped surface corresponding approximately to the facets E₁, E₂, E₃, E₄, E₅, E₆, E₇, defined by angle Σ₁ of about fifteen degrees, Σ₂ of about thirty degrees, Σ₃ of about forty five degrees, Σ₄ of about sixty degrees, Σ₅ of about seventy five degrees, Σ₆ of about ninety degrees, or Σ₇ of about one hundred five degrees.

24. A cylinder head for aircraft engines, said cylinder head configured for attachment to a cylinder body having a cylinder bore of diameter defined by a sidewall, and an outer end, the cylinder bore configured to operably confine a piston of selected stroke distance, and with the piston thereby define a swept displacement volume, said cylinder head comprising:
a head portion having therein
an inlet passageway defined by inlet passageway sidewalls, said inlet passageway extending between an upstream inlet and an intake valve seat, and defining an inlet passageway volume;
an exhaust passageway defined by exhaust passageway sidewalls, extending between an exhaust valve seat and an exhaust outlet;
wherein said inlet passageway volume is about thirty percent (30%), or less, of said swept displacement volume;
said intake valve seat comprising an insert having intake valve seat sidewalls, wherein said intake valve seat sidewalls comprise a shaped surface having a plurality of facets in an inlet airflow direction of I₇ I₆, I₅, I₄, I₃, I₂, and I₁, and, defined respectively by angle β₇ of about one hundred five degrees, β₆ of about ninety degrees, β₅ of about seventy five degrees, β₄ of about sixty degrees, β₃ of about forty five degrees, β₂ of about thirty degrees, and β₁ of about fifteen degrees; and
said exhaust valve seat comprising an insert having exhaust valve seat sidewalls, wherein said exhaust valve seat sidewalls comprise a shaped surface having a plurality of facets in an exhaust gas direction E₁, E₂, E₃, E₄, E₅, E₆, or E₇, defined respectively by angles Σ₁ of about fifteen degrees, Σ₂ of about thirty degrees, Σ₃ of about forty five degrees, Σ₄ of about sixty degrees, Σ₅ of about seventy five degrees, Σ₆ of about ninety degrees, or Σ₇ of about one hundred five degrees.

25. A cylinder for aircraft engines as set forth in claim 24, wherein said intake valve seat and said exhaust valve seat are configured for parallel valve operation.

26. A cylinder for aircraft engines as set forth in claim 24, wherein said intake valve seat and said exhaust valve seat are configured for angled valve operation.

27. A cylinder head for aircraft engines, said cylinder head configured for attachment to a cylinder body having a cylinder bore of diameter defined by a sidewall, and an outer end, the cylinder bore configured to operably confine a piston of selected stroke distance, and with the piston thereby define a swept displacement volume, said cylinder head comprising:
a head portion having therein
an inlet passageway defined by inlet passageway sidewalls, said inlet passageway extending between an upstream inlet and an intake valve seat, and defining an inlet passageway volume;
an exhaust passageway defined by exhaust passageway sidewalls, extending between an exhaust valve seat and an exhaust outlet;
wherein said inlet passageway volume is about thirty percent (30%), or less, of said swept displacement volume;
said intake valve seat comprising an insert having intake valve seat sidewalls, wherein said intake valve seat sidewalls comprise a smooth, curve-fitted shaped surface corresponding in curvature to a plurality of facets in an inlet airflow direction of I₇ I₆, I₅, I₄, I₃, I₂, and I₁, and, defined respectively by angle β₇ of about one hundred five degrees, β₆ of about ninety degrees, β₅ of about seventy five degrees, β₄ of about sixty degrees, β₃ of about forty five degrees, β₂ of about thirty degrees, and β₁ of about fifteen degrees; and
said exhaust valve seat comprising an insert having exhaust valve seat sidewalls, wherein said exhaust valve seat sidewalls comprise a smooth, curve-fitted shaped surface corresponding in curvature to a plurality of facets in an exhaust gas direction E₁, E₂, E₃, E₄, E₅, E₆, or E₇, defined respectively by angles Σ₁ of about fifteen degrees, Σ₂ of about thirty degrees, Σ₃ of about forty five degrees, Σ₄ of about sixty degrees, Σ₅ of about seventy five degrees, Σ₆ of about ninety degrees, or Σ₇ of about one hundred five degrees.
